(19) United States
(12) Patent Application Publication
(10) Pub. No.: US 2015/0054795 A1
(43) Pub. Date: Feb. 26, 2015

(54) TERMINAL DEVICE

(71) Applicant: FUJITSU LIMITED, Kawasaki-shi (JP)

(72) Inventor: Katsunori TAKAMI, Tachikawa (JP)

(21) Appl. No.: 14/320,968

(22) Filed: Jul. 1, 2014

(30) Foreign Application Priority Data
Aug. 26, 2013 (JP) 2013-174758

(51) Int. Cl. G06F 3/041

(52) U.S. Cl. CPC G06F 3/0418
USPC 345/178

(57) ABSTRACT

A terminal device includes a memory, and a processor coupled to the memory, configured to acquire position information indicating a contact position of an indicator with respect to a touch panel, detect, based on the acquired position information, a preceding contact operation and a succeeding contact operation performed before and after a non-contact period with respect to the touch panel, and determine that the preceding contact operation and the succeeding contact operation are one continuous operation when an elapsed time and a positional interval satisfy a given condition, the elapsed time being from finish of the preceding contact operation being detected until start of the succeeding contact operation being detected, and the positional interval being between a finish position at which the finish of the preceding contact operation has been detected and a start position at which the start of the succeeding contact operation has been detected.

### CROSS-REFERENCE TO RELATED APPLICATION

This application is based upon and claims the benefit of priority of the prior Japanese Patent Application No. 2013-174758, filed on Aug. 26, 2013, the entire contents of which are incorporated herein by reference.

### FIELD

The embodiments discussed herein are related to a terminal device.

### BACKGROUND

A technology is known in which, after a tap operation on a touch panel has been detected, if drag operations on the touch panel are repeatedly detected with non-detection periods within a predetermined time therebetween, it is determined that these detected drag operations are one continuous drag operation. Furthermore, a technology is also known in which, if a drag operation on a touch panel is interrupted due to the terminal device receiving some kind of impact and shaking while the drag operation is being performed on the touch panel, it is determined that the drag operations before and after the interruption are one continuous drag operation. These technologies are disclosed in, for example, Japanese National Publication of International Patent Application No. 11-506559 and Japanese Laid-open Patent Publication No. 2012-221359.

### SUMMARY

According to an aspect of the invention, a terminal device includes a memory, and a processor coupled to the memory, configured to acquire position information indicating a contact position of an indicator with respect to a touch panel, detect, based on the acquired position information, a preceding contact operation and a succeeding contact operation performed before and after a non-contact period with respect to the touch panel, and determine that the preceding contact operation and the succeeding contact operation are one continuous operation when an elapsed time and a positional interval satisfy a given condition, the elapsed time being from finish of the preceding contact operation being detected until start of the succeeding contact operation being detected, and the positional interval being between a finish position at which the finish of the preceding contact operation has been detected and a start position at which the start of the succeeding contact operation has been detected.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram depicting an example of the main functions of a smart device according to a first embodiment and a second embodiment;

FIG. 2 is a block diagram depicting an example of the hardware configuration of the smart device according to the first embodiment;

FIG. 3 is a schematic diagram depicting an example of the configuration of an applied operation table included in the smart device according to the first embodiment;

FIG. 4 is a cross-sectional diagram depicting an example of the schematic layered structure of a touch panel display included in the smart device according to the first embodiment;

FIG. 5 is a flowchart depicting an example of the flow of basic operation detection processing according to the first embodiment;

FIG. 6 is a flowchart depicting an example of the flow of applied operation detection processing according to the first embodiment;

FIG. 7 is a flowchart depicting an example of the flow of held notification processing according to the first embodiment;

FIG. 8 is a flowchart depicting an example of the flow of tap operation processing according to the first embodiment;

FIG. 9 is a flowchart depicting an example of the flow of mid-holding processing according to the first embodiment;

FIG. 10 is a flowchart depicting an example of the flow of first pre-elapse processing according to the first embodiment;

FIG. 11 is a flowchart depicting an example of the flow of DG operation processing according to the first embodiment;

FIG. 12 is a flowchart depicting an example of the flow of DG starting processing according to the first embodiment;

FIG. 13 is a flowchart depicting an example of the flow of erroneous operation response processing according to the first embodiment;

FIG. 14 is a flowchart depicting an example of the flow of correct operation response processing according to the first embodiment;

FIG. 15 is a flowchart depicting an example of the flow of second pre-elapse processing according to the first embodiment;

FIG. 16 is a flowchart depicting an example of the flow of DG finishing processing according to the first embodiment;

FIG. 17 is a flowchart depicting an example of the flow of first finishing processing according to the first embodiment;

FIG. 18 is a flowchart depicting an example of the flow of second finishing processing according to the first embodiment;

FIG. 19 is a flowchart depicting an example of the flow of third finishing processing according to the first embodiment;

FIG. 20 is a flowchart depicting an example of the flow of DG moving processing according to the first embodiment;

FIG. 21 is a flowchart depicting an example of the flow of first moving processing according to the first embodiment;

FIG. 22 is a flowchart depicting an example of the flow of second moving processing according to the first embodiment;

FIG. 23 is a flowchart depicting an example of the flow of third moving processing according to the first embodiment;

FIG. 24 is a flowchart depicting an example of the flow of time-elapsed notification processing according to the first embodiment;

FIG. 25 is a schematic diagram depicting an example of the positional relationship between a drag operation and a tap operation performed on a touch panel;

FIG. 26A is a mode diagram depicting an example of a drag operation mode in the case where it is determined that a drag finish operation is an erroneous operation due to an indicating body catching on a film during a drag operation on a touch panel and a non-detection period being generated by the touch panel;

FIG. 26B is a mode diagram depicting an example of a drag operation mode in the case where it is determined that a drag finish operation is an erroneous operation due to an indicating body moving over an air bubble-containing location during a drag operation on a touch panel and a non-detection period being generated by the touch panel;

FIG. 27 is a schematic diagram provided for illustrating a method for calculating an angle formed between a finishing slide direction included in a drag operation performed on a touch panel and the direction from the finish position of the drag operation toward the position of a tap operation performed on the touch panel;

FIG. 28 is a schematic diagram depicting an example of the positional relationship between a first drag operation and a second drag operation performed on a touch panel;

FIG. 29 is a schematic diagram depicting an example of the positional relationship between a first drag operation, a tap operation, and a second drag operation in the case where a tap operation has been performed on a line segment that joins the finish position of the first drag operation performed on a touch panel and the start position of the second drag operation;

FIG. 30 is a block diagram depicting an example of the hardware configuration of a smart device according to the second embodiment;

FIG. 31 is a schematic diagram depicting an example of the configuration of a flag management table included in the smart device according to the second embodiment;

FIG. 32 is a flowchart depicting an example of the flow of tap operation processing according to the second embodiment;

FIG. 33 is a flowchart depicting an example of the flow of DG operation response processing according to the second embodiment; and

FIG. 34A is a flowchart depicting an example of the flow of DG starting processing according to the second embodiment.

FIG. 34B is a flowchart depicting an example of the flow of DG starting processing according to the second embodiment.

### DESCRIPTION OF EMBODIMENTS

In all of the prior art, if a non-detection period has been generated by a touch panel, it is difficult to specify whether the non-detection period has been generated by an erroneous operation, or whether the non-detection period has been generated by an operation other than an erroneous operation. Operations and so forth with which the user intentionally causes a non-detection period to be generated may be given as examples of operations other than an erroneous operation.

Here, an erroneous operation refers to, for example, an operation that, although the user intended to perform a slide operation such as a drag operation on the touch panel, causes a non-detection period to be generated by a touch panel at a timing not intended by the user. An example of an erroneous operation referred to here may be an erroneous operation that occurs due to the frictional force of the contact location between an indicating body such as a finger and the touch panel, or an air bubble being included between a film attached to the front surface of the touch panel and the surface of the touch panel. An erroneous operation that occurs due to frictional force refers to, for example, an operation in which the frictional force between the indicating body and the touch panel increases during a slide operation, the indicating body catches on the touch panel, and the indicating body momentarily separates from the touch panel. Furthermore, an erroneous operation that occurs due to an air bubble being included between a film and the front surface of the touch panel refers to an operation in which the indicating body momentarily separates from the touch panel due to the indicating body moving over an air bubble-containing location during a slide operation.

Hereafter, examples of embodiments of the disclosed technology are described in detail with reference to the drawings. It ought to be noted that although in the following description a smart device is described as an example of a terminal device according to the disclosed technology, the disclosed technology is not restricted to this. The disclosed technology may be applied to a variety of terminal devices that have a touch panel. A terminal device is, for example, a personal computer, a game device, a car navigation device, a mobile telephone, or a digital camera or the like.

### First Embodiment

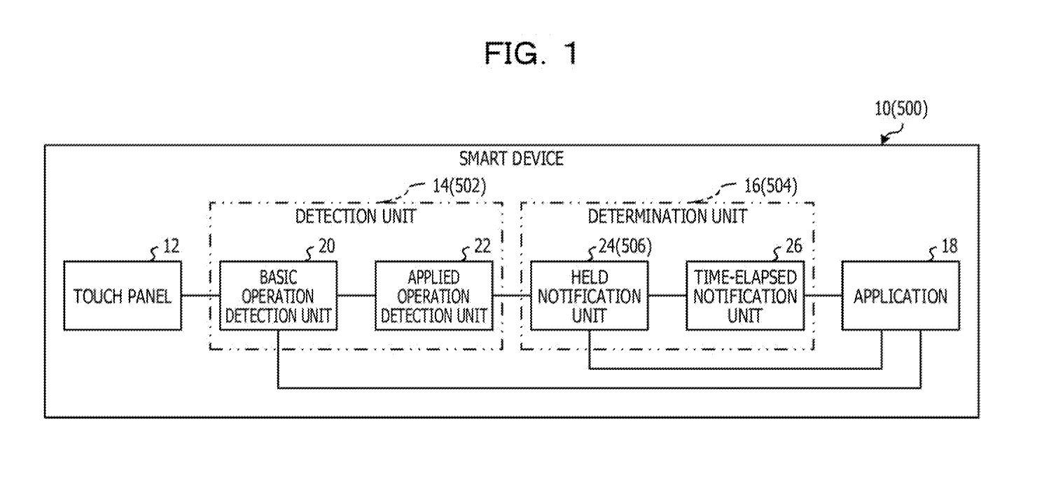

A smart device 10 depicted in FIG. 1 as an example includes a touch panel 12, a detection unit 14, a determination unit 16, and an application 18.

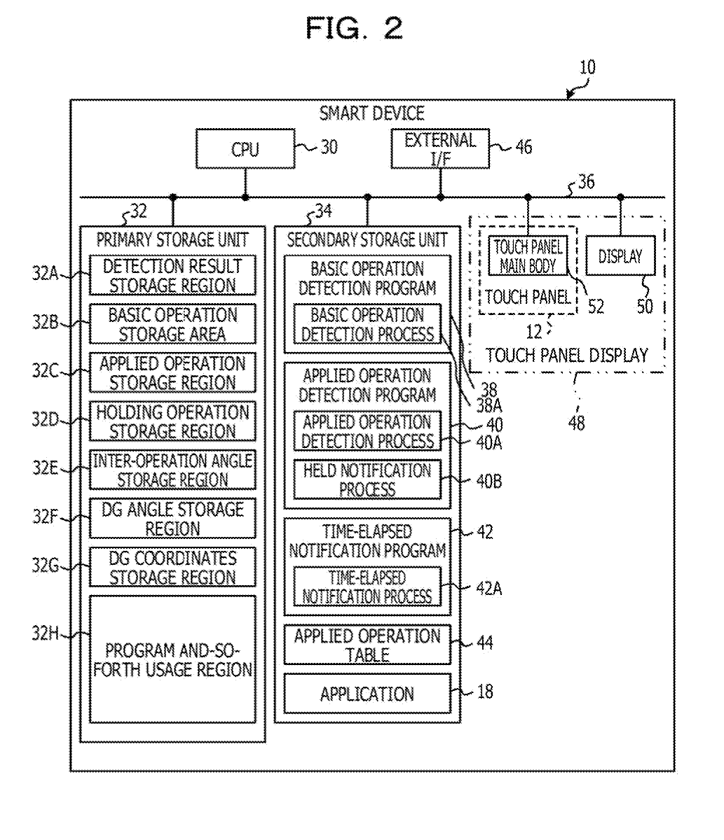

The touch panel 12 is, for example, a transparent touch panel overlaid on a display. The touch panel 12 detects contact by an indicating body such as a finger or a stylus pen. The touch panel 12 outputs detection result information indicating the presence/absence of contact by an indicating body on the touch panel 12, to a predetermined output destination (for example, a CPU 30 (see FIG. 2) described hereafter) at predetermined intervals (for example, 100 milliseconds). Furthermore, position information indicating the position of contact by the indicating body on the touch panel 12 is included in the detection result information if the touch panel 12 has detected contact by the indicating body, and the position information is not included if the touch panel 12 has not detected contact by the indicating body. Here, position information refers to, for example, two-dimensional coordinates (hereafter referred to as “coordinates”) that are able to specify a position on the touch panel 12.

The application 18 is, for example, an application program (hereafter referred to as an “application”) that has been downloaded via the Internet in accordance with an instruction of the user of the smart device 10 (hereafter referred to as the “user”), and receives instructions input by the user via the touch panel 12.

The detection unit 14 acquires detection result information from the touch panel 12, and based on coordinates included in the acquired detection result information, detects a preceding contact operation and a succeeding contact operation performed before and after a non-contact period on the touch panel 12. Furthermore, the detection result information is, for example, acquired at predetermined intervals by the detection unit 14.

Based on the elapsed time during the operation and the positional interval between a finish position at which the finish of the preceding contact operation is detected by the detection unit 14 and a start position at which the start of the succeeding contact operation is detected, the determination unit 16 determines whether or not the finish of the preceding contact operation has been erroneously detected. Furthermore, if the elapsed time during the operation and the positional interval between the finish position at which the finish of the preceding contact operation is detected by the detection unit 14 and the start position at which the start of the succeeding contact operation is detected have satisfied a predetermined condition, the determination unit 16 determines that the preceding contact operation and the succeeding contact operation are one continuous operation. Here, the elapsed time during the operation refers to the elapsed time from the finish of the preceding contact operation being detected by the detection unit 14 to the start of the succeeding contact operation being detected.

Furthermore, hereafter, for convenience of explanation, the finish position at which the finish of the preceding contact operation is detected by the detection unit 14 is referred to as the “preceding operation finish position”, and the start position at which the start of the succeeding contact operation is detected by the detection unit 14 is referred to as the “succeeding operation start position”. Furthermore, hereafter, for convenience of explanation, the elapsed time during the operation is referred to as the “elapsed time”, and the positional interval between the finish position at which detection of the preceding contact operation is finished by the detection unit 14 and the start position at which detection of the succeeding contact operation is started is referred to as the “positional interval”. Furthermore, hereafter, for convenience of explanation, the finish operation included in the preceding contact operation is referred to as the “finish operation”.

If a preceding slide operation is detected as the preceding contact operation by the detection unit 14, the determination unit 16 determines, based on a first angle, the elapsed time, and the positional interval, whether or not the finish of the preceding slide operation has been erroneously detected. Furthermore, if a preceding slide operation is detected as the preceding contact operation by the detection unit 14, and the first angle, the elapsed time, and the positioned interval have satisfied a predetermined condition, the determination unit 16 determines that the preceding contact operation and the succeeding contact operation are one continuous operation. Here, the first angle refers to the angle formed between the finishing slide direction in the preceding slide operation (for example, the drag direction of a drag finish operation described hereafter) and the direction from the preceding operation finish position toward the succeeding operation start position (hereafter referred to as the “inter-operation direction”).

If a preceding slide operation is detected as the preceding contact operation by the detection unit 14, the first angle is less than a first threshold value, the elapsed time is less than a second threshold value, and the positional interval is less than a third threshold value, the determination unit 16 determines that the finish of the preceding slide operation has been erroneously detected.

If a succeeding tap-like operation is detected, the first angle is less than the first threshold value, the elapsed time is less than the second threshold value, and the positional interval is less than the third threshold value, the determination unit 16 determines that the succeeding tap-like operation is part of the preceding slide operation. It ought to be noted that a succeeding tap-like operation refers to a tap-like operation that has been detected as a succeeding contact operation by the detection unit 14. A tap-like operation refers to, for example, a tap operation, a flick operation, and a double-tap operation described hereafter.

If a succeeding slide operation is detected, the first angle is less than the first threshold value, the elapsed time is less than the second threshold value, the positional interval is less than the third threshold value, and a second angle is equal to or less than a fourth threshold value, the determination unit 16 determines that the succeeding slide operation is part of the preceding slide operation. Here, the second angle refers to the angle formed between the inter-operation direction and a starting slide direction in the succeeding slide operation (for example, the drag direction of a drag start operation described hereafter). Furthermore, the succeeding slide operation refers to a slide operation that has been detected as a succeeding contact operation by the detection unit 14.

If a preceding tap-like operation is detected, the elapsed time is less than a fifth threshold value, and the positional interval is less than a sixth threshold value, the determination unit 16 determines that the finish of the preceding tap-like operation has been erroneously detected. It ought to be noted that the preceding tap-like operation refers to a tap-like operation that has been detected as a preceding contact operation by the detection unit 14.

The detection unit 14 includes a basic operation detection unit 20 and an applied operation detection unit 22. The basic operation detection unit 20 acquires detection result information from the touch panel 12, and based on coordinates included in the acquired detection result information, detects a basic operation. The basic operation detection unit 20 then generates basic operation information that indicates the detected basic operation, and notifies the generated basic operation information to the application 18. Here, a basic operation refers to, for example, a contact start operation, a movement operation, and a contact finish operation. A contact start operation refers to an operation with which an indicating body is brought into contact with the touch panel 12. A movement operation refers to an operation with which a contact indication position, which is a position that is indicated by the indicating body being brought into contact with the touch panel 12 (for example, a position indicated by a contact start operation), is made to continuously move. A contact finish operation refers to an operation with which the indicating body separates from the touch panel 12 (an operation with which the contact state of the indicating body on the touch panel 12 is released).

Based on the basic operation information generated by the basic operation detection unit 20, the applied operation detection unit 22 detects applied operations that define each of the preceding contact operation and the succeeding contact operation in operation units in which the finish of the preceding contact operation is able to be detected. The applied operation detection unit 22 then generates applied operation information that indicates the detected applied operations.

The determination unit 16 notifies, to the application 18, applied operation information selected based on a determination result, from the applied operation information generated by the applied operation detection unit 22.

Here, examples of a preceding contact operation and a succeeding contact operation may be a tap operation, a flick operation, a double-tap operation, a long-press operation, a drag operation, a pinch-open (pinch-out) operation, and a pinch-close (pinch-in) operation. These operations are broadly divided into single operations that are defined by one operation unit and multiple operations that are defined by a plurality of operation units. A tap operation, a flick operation, and a double-tap operation are examples of preceding tap-like operations and succeeding tap-like operations in the disclosed technology, and belong to the single operations. Therefore, each of a tap operation, a flick operation, and a double-tap operation are defined by a single applied operation (here, examples are each of a tap operation, a flick operation, and a double-tap operation). A drag operation (an example of a preceding slide operation and a succeeding slide operation in the disclosed technology), a long-press operation, a pinch-open operation, and a pinch-close operation belong to the multiple operations. Therefore, each of a long-press operation, a drag operation, a pinch-open operation, and a pinch-close operation are defined by a plurality of applied operations (for example, in the case of a drag operation, a drag start operation, a drag movement operation, and a drag finish operation described hereafter).

A tap operation refers to an operation with which an indicating body is made to tap the touch panel 12 once. A flick operation refers to an operation with which the movement distance of a movement operation that causes a contact indication position to be moved is equal to or greater than a predetermined distance (for example, 2 millimeters), and the movement operation is finished by the indicating body being separated from the touch panel 12 in less than a first set time (for example, 300 milliseconds) from the movement operation being started. A double-tap operation refers to an operation with which the indicating body is made to tap the touch panel 12 twice with a non-detection period that is less than the first set time between the two tap operations.

A drag operation refers to an operation with which a contact indication position, which is a position that is indicated by the indicating body being brought into contact with the touch panel 12, is made to continuously move for the first set time or more. A drag operation is defined by the three applied operations of a drag start operation, a drag movement operation, and a drag finish operation. The drag start operation refers to the operation when a drag operation is started. The drag finish operation refers to the operation when a drag operation is finished. A drag movement operation refers to, in a drag operation, the operation between the drag start operation and the drag finish operation.

A long-press operation refers to an operation with which the indicating body is brought into contact with the touch panel 12 continuously for a second set time (for example, one second) or more without being made to move from the contact indication position. A long-press operation is defined by the two applied operations of a long-press start operation and a long-press finish operation. A long-press start operation refers to the operation when a long-press operation is started. A long-press finish operation refers to the operation when a long-press operation is finished.

A pinch-open operation is also commonly referred to as a pinch-out operation, and refers to an operation with which the positional interval between two contact indication positions is widened. A pinch-open operation is defined by the two applied operations of a pinch-open start operation and a pinch-open finish operation. A pinch-open start operation refers to the operation when a pinch-open operation is started. A pinch-open finish operation refers to the operation when a pinch-open operation is finished.

A pinch-close operation is also commonly referred to as a pinch-in operation, and refers to an operation with which the positional interval between two contact indication positions is narrowed. A pinch-close operation is defined by the two applied operations of a pinch-close start operation and a pinch-close finish operation. A pinch-close start operation refers to the operation when a pinch-close operation is started. A pinch-close finish operation refers to the operation when a pinch-close operation is finished.

The applied operation information includes parameters. The parameters refer to coordinates and the time at which the applied operation detection unit 22 acquired the coordinates (acquisition time). When a tap operation on the touch panel 12 is detected, tap operation information that indicates the tap operation and also includes parameters is generated as applied operation information by the applied operation detection unit 22. Furthermore, when a flick operation on the touch panel 12 is detected, flick operation information that indicates the flick operation and also includes parameters is generated as applied operation information by the applied operation detection unit 22. Furthermore, when a double-tap operation on the touch panel 12 is detected, double-tap operation information that indicates the double-tap operation and also includes parameters is generated as applied operation information by the applied operation detection unit 22.

Furthermore, when a long-press start operation on the touch panel 12 is detected, long-press start operation information (hereafter referred to as “LP start information”) that indicates the long-press start operation and also includes parameters is generated as applied operation information by the applied operation detection unit 22. Furthermore, when a long-press finish operation on the touch panel 12 is detected, long-press finish operation information (hereafter referred to as “LP finish information”) that indicates the long-press finish operation and also includes parameters is generated as applied operation information by the applied operation detection unit 22.

Furthermore, when a drag start operation on the touch panel 12 is detected, drag start operation information (hereafter referred to as “DG start information”) that indicates the drag start operation and also includes parameters is generated as applied operation information by the applied operation detection unit 22. Furthermore, when a drag movement operation on the touch panel 12 is detected, drag movement operation information (hereafter referred to as “DG movement information”) that indicates the drag movement operation and also includes parameters is generated as applied operation information by the applied operation detection unit 22. Furthermore, when a drag finish operation on the touch panel 12 is detected, drag finish operation information (hereafter referred to as “DG finish information”) that indicates the drag finish operation and also includes parameters is generated as applied operation information by the applied operation detection unit 22.

Furthermore, when a pinch-open start operation on the touch panel 12 is detected, pinch-open start operation information (hereafter referred to as “PO start information”) that indicates the pinch-open start operation and also includes parameters is generated as applied operation information by the applied operation detection unit 22. Furthermore, when a pinch-open finish operation on the touch panel 12 is detected, pinch-open finish operation information (hereafter referred to as “PO finish information”) that indicates the pinch-open finish operation and also includes parameters is generated as applied operation information by the applied operation detection unit 22.

Furthermore, when a pinch-close start operation on the touch panel 12 is detected, pinch-close start operation information (hereafter referred to as “PC start information”) that indicates the pinch-close start operation and also includes parameters is generated as applied operation information by the applied operation detection unit 22. Furthermore, when a pinch-close finish operation on the touch panel 12 is detected, pinch-close finish operation information (hereafter referred to as “PC finish information”) that indicates the pinch-close finish operation and also includes parameters is generated as applied operation information by the applied operation detection unit 22.

Moreover, the parameters included in each of the PO start information, the PO finish information, the PC start information, and the PC finish information are first coordinates, second coordinates, a first acquisition time, and a second acquisition time. Here, the first coordinates mean coordinates that specify one contact indication position from among two contact indication positions, and the second coordinate mean coordinates that specify the other contact indication position. Furthermore, the first acquisition time means the time at which the detection unit 14 acquired the first coordinates, and the second acquisition time means the time at which the detection unit 14 acquired the second coordinates.

The determination unit 16 includes a held notification unit 24 and a time-elapsed notification unit 26. The held notification unit 24 holds notifications, to the application 18, of applied operation information generated by the applied operation detection unit 22. The held notification unit 24 then notifies, to the application 18, applied operation information that is selected based on a determination result, from the applied operation information that is being held.

If the holding time of the applied operation information that is being held by the held notification unit 24 has exceeded a predetermined time, the time-elapsed notification unit 26 notifies, to the application 18, the applied operation information that is being held.

As depicted in FIG. 2 as an example, the smart device 10 includes a central processing unit (CPU) 30, a primary storage unit 32, and a secondary storage unit 34, and the CPU 30, the primary storage unit 32, and the secondary storage unit 34 are connected via a bus 36. Furthermore, the primary storage unit 32 means a volatile memory, and refers to a random-access memory (RAM), for example. The secondary storage unit 34 means a nonvolatile memory, and refers to a flash memory or a hard disk drive (HDD), for example.

The primary storage unit 32 has a detection result storage region 32A, a basic operation storage region 32B, an applied operation storage region 32C, a holding operation storage region 32D, and an inter-operation angle storage region 32E. Furthermore, the primary storage unit 32 has a drag angle storage region (DG angle storage region) 32F, a drag coordinates storage region (DG coordinates storage region) 32G, and a program and-so-forth usage region 32H.

The detection result storage region 32A is a storage region in which detection result information is temporarily stored. The basic operation storage region 32B is a storage region in which basic operation information is temporarily stored. The applied operation storage region 32C is a storage region in which applied operation information is temporarily stored.

The holding operation storage region 32D is a storage region in which applied operation information is temporarily stored in order to hold notifications of applied operation information to the application 18. Furthermore, applied operation information other than DG movement information is stored in the holding operation storage region 32D. Therefore, notifications of DG movement information to the application 18 are not held.

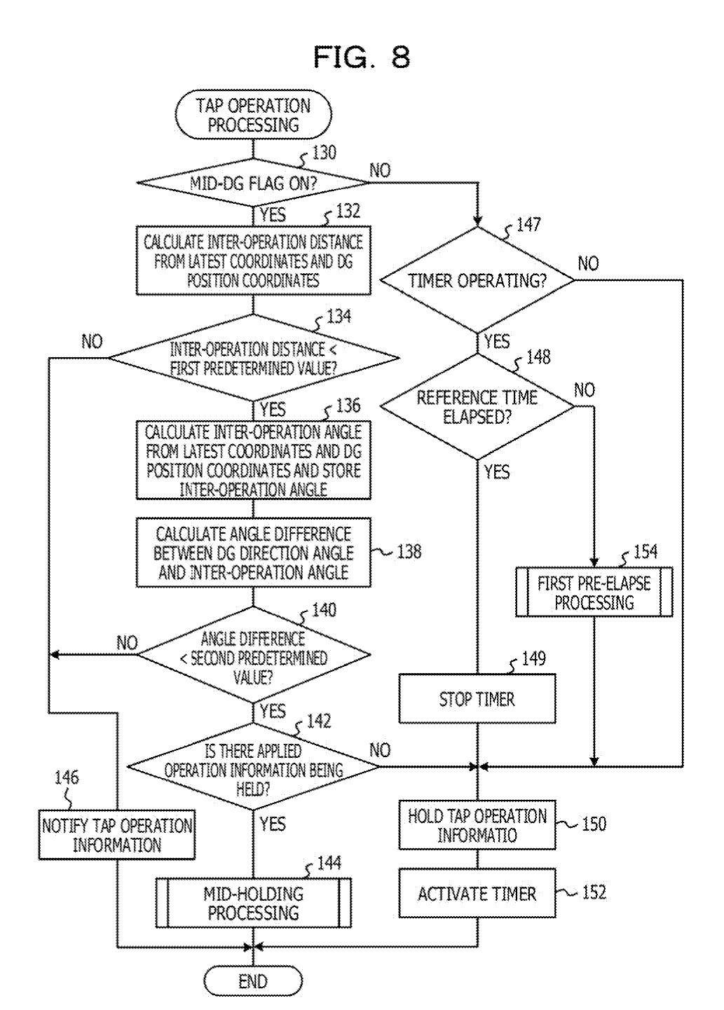

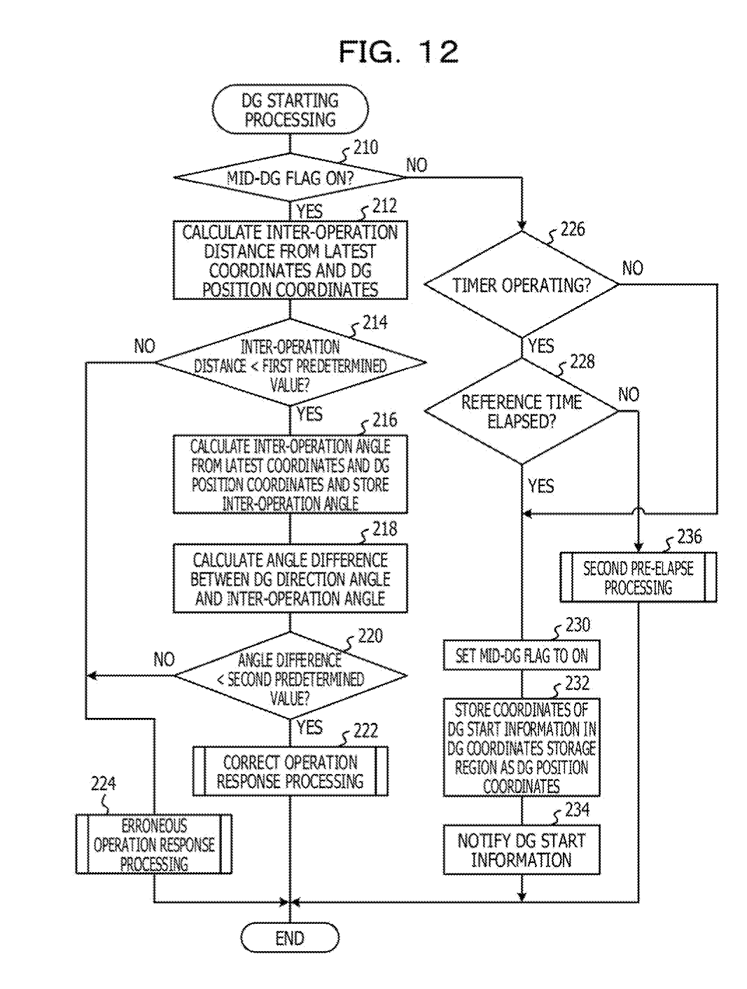

The inter-operation angle storage region 32E is a storage region in which an inter-operation angle (for example, see step 136 in FIG. 8 and step 216 in FIG. 12) described hereafter is temporarily stored.

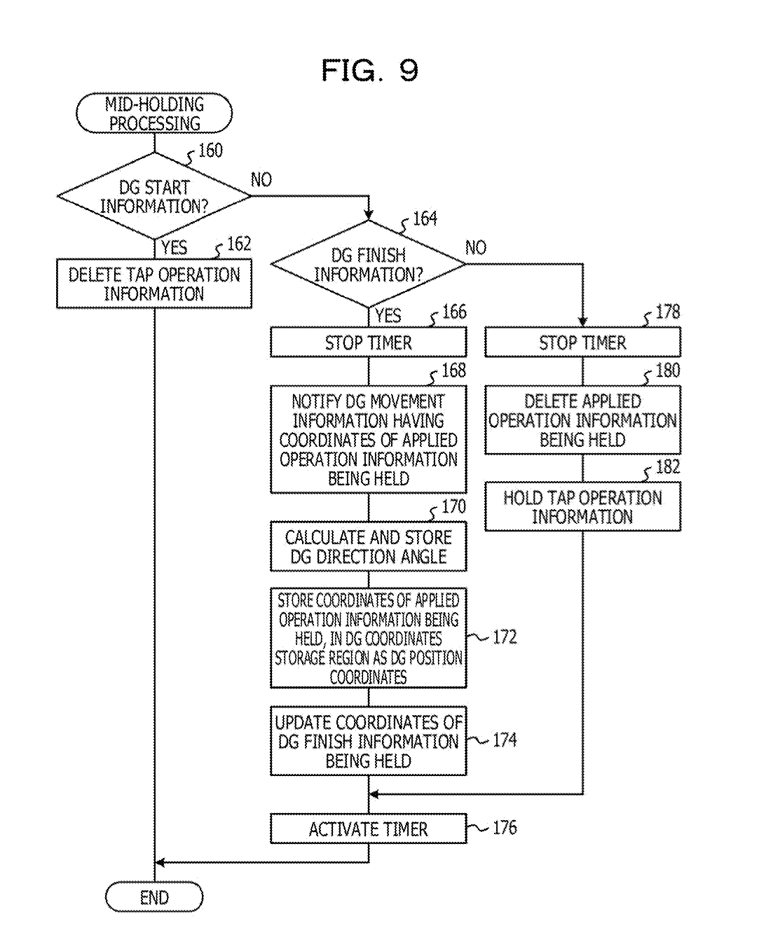

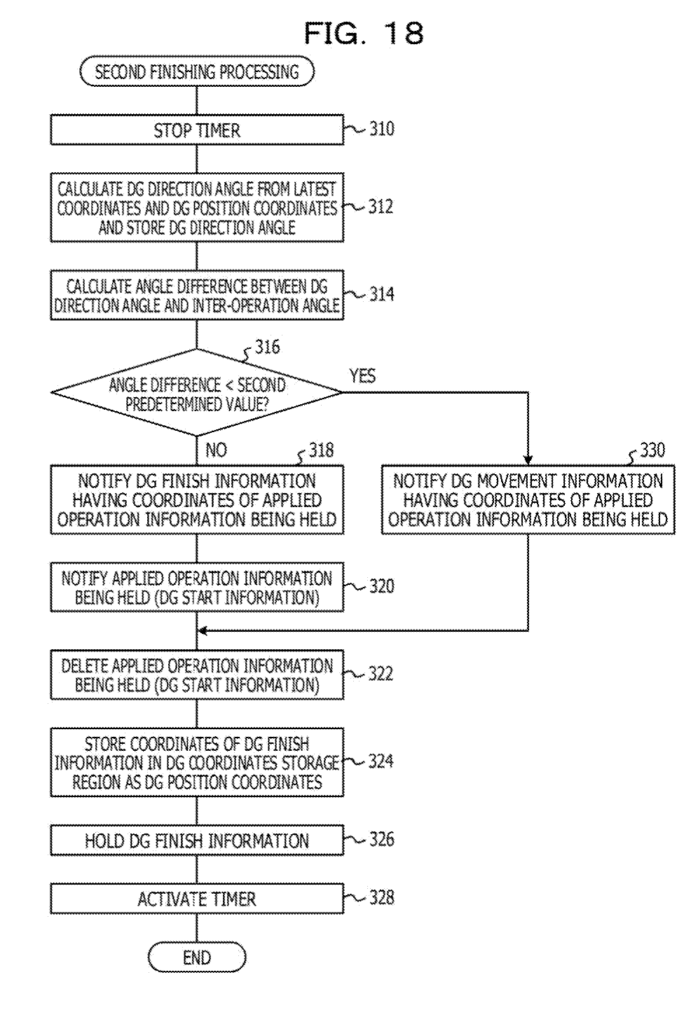

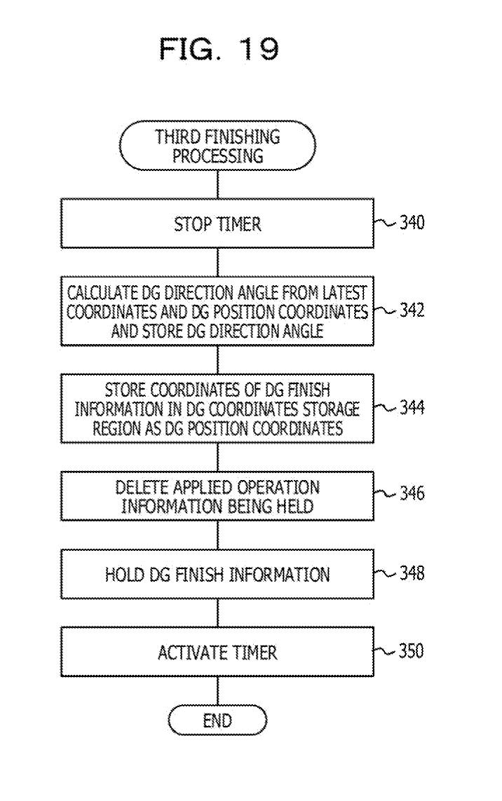

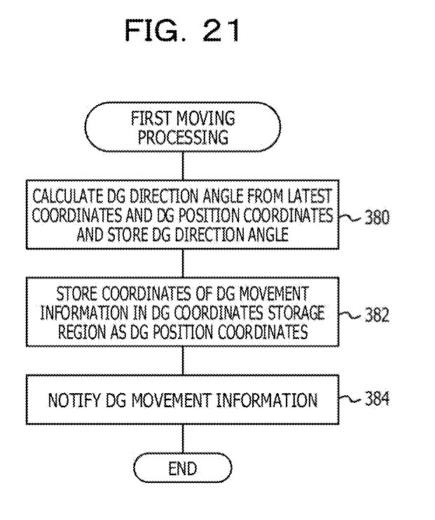

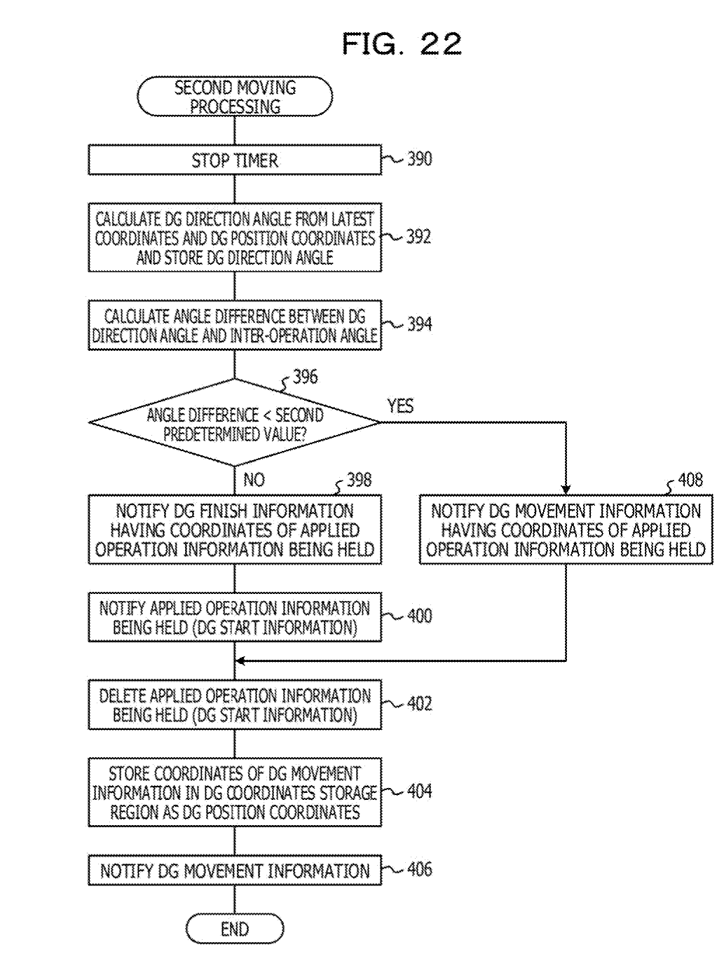

The DG angle storage region 32F is a storage region in which a drag direction angle (DG direction angle (for example, see step 170 in FIG. 9, step 312 in FIG. 18, step 342 in FIG. 19, step 380 in FIG. 21, and step 392 in FIG. 22)) described hereafter is temporarily stored.

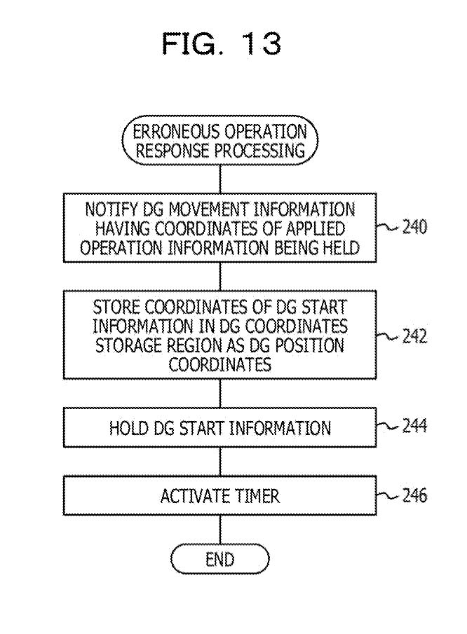

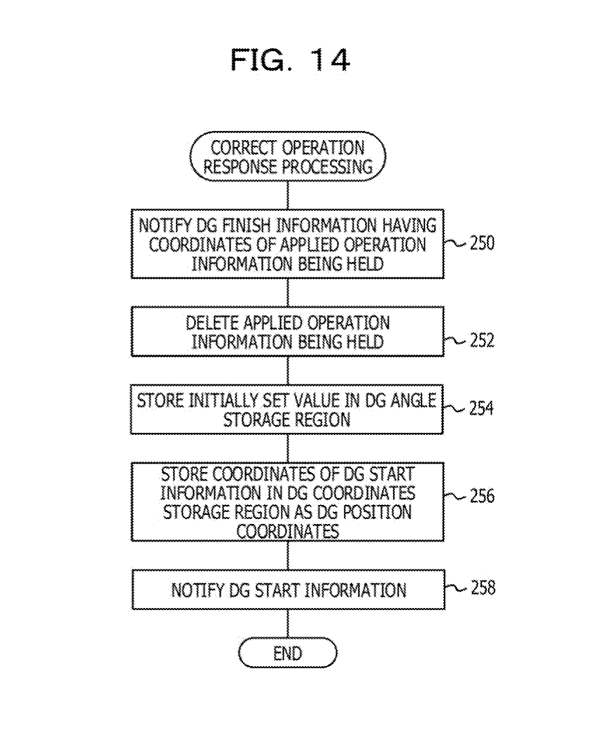

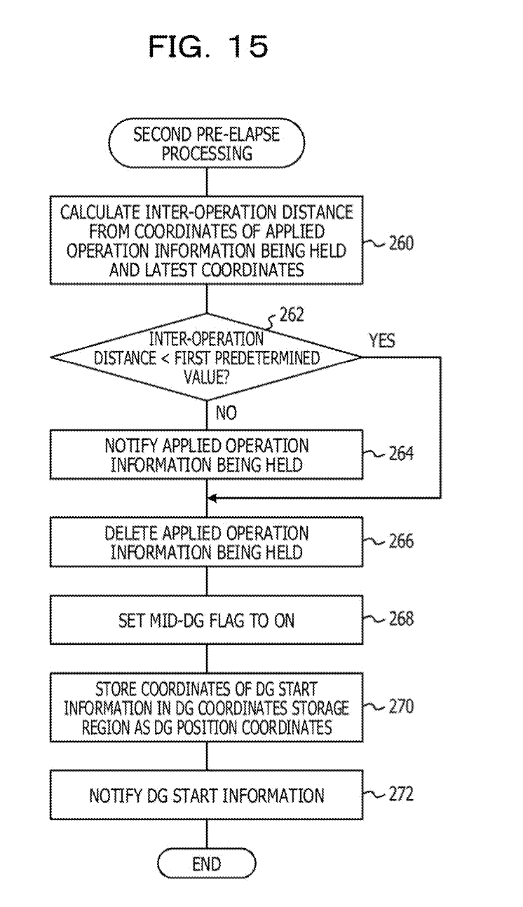

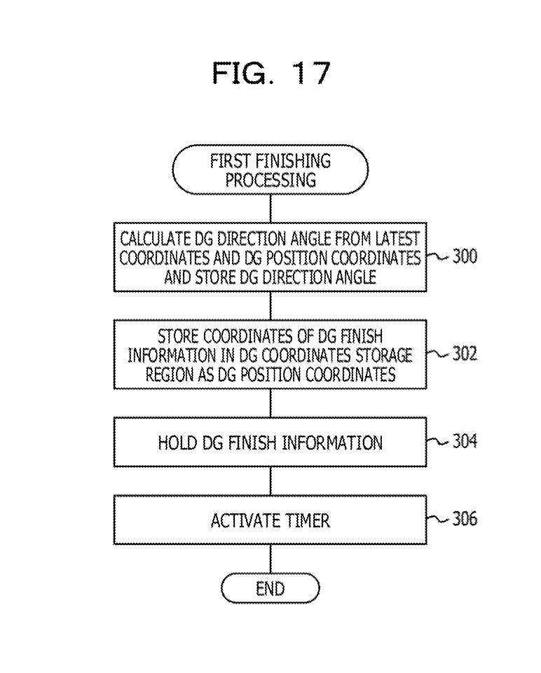

The DG coordinates storage region 32G is a storage region in which drag position coordinates (DG position coordinates (for example, see step 172 in FIG. 9, step 242 in FIG. 13, step 256 in FIG. 14, step 270 in FIG. 15, and step 302 in FIG. 17)) described hereafter are temporarily stored. Furthermore, in the DG angle storage region 32F, an angle the actual calculation of which is not possible (for example, 10,000 degrees) is stored as an initially set value, and the calculated DG direction angle is overwritten and saved each time the DG direction angle is calculated.

The program and-so-forth usage region 32H is a storage region for using the application 18, a basic operation detection program 38 described hereafter, an applied operation detection program 40, a time-elapsed notification program 42, and an applied operation table 44.

The secondary storage unit 34 stores the application 18. Furthermore, the secondary storage unit 34 stores the basic operation detection program 38, which is an example of a touch operation detection program in the disclosed technology. Furthermore, the secondary storage unit 34 stores the applied operation detection program 40, which is an example of a touch operation detection program in the disclosed technology. Furthermore, the secondary storage unit 34 stores the time-elapsed notification program 42, which is an example of a touch operation detection program in the disclosed technology. In addition, the secondary storage unit 34 stores the applied operation table 44. It ought to be noted that, hereafter, the basic operation detection program 38, the applied operation detection program 40, and the time-elapsed notification program 42 are referred to as a “program” if these do not have to be differentiated and described.

The CPU 30 reads the basic operation detection program 38 from the secondary storage unit 34 and deploys this in the program and-so-forth usage region 32H, and executes processes of the basic operation detection program 38. The basic operation detection program 38 has a basic operation detection process 38A. The CPU 30 executes the basic operation detection process 38A, and thereby operates as the basic operation detection unit 20 depicted in FIG. 1.

The CPU 30 reads the applied operation detection program 40 from the secondary storage unit 34 and deploys this in the program and-so-forth usage region 32H, and executes processes of the applied operation detection program 40. The applied operation detection program 40 has an applied operation detection process 40A and a held notification process 40B. The CPU 30 executes the applied operation detection process 40A, and thereby operates as the applied operation detection unit 22 depicted in FIG. 1. The CPU 30 executes the held notification process 40B, and thereby operates as the held notification unit 24 depicted in FIG. 1.

The CPU 30 reads the time-elapsed notification program 42 from the secondary storage unit 34 and deploys this in the program and-so-forth usage region 32H, and executes processes of the time-elapsed notification program 42. The time-elapsed notification program 42 has a time-elapsed notification process 42A. The CPU 30 executes the time-elapsed notification process 42A, and thereby operates as the time-elapsed notification unit 26 depicted in FIG. 1.

It ought to be noted that, although an example is given here of the case where a program is read from the secondary storage unit 34, the program does not necessarily have to be stored in the secondary storage unit 34 from the beginning. For example, the program may first be stored in an arbitrary “portable storage medium” such as a solid state drive (SSD), an IC card, a magneto-optical disk, or a CD-ROM that is used connected to the smart device 10. The CPU 30 may then acquire the program from this portable storage medium and execute the program. Furthermore, the program may be stored in a computer connected to the smart device 10 by way of a communication line, or in a storage unit of an external electronic computer such as a server device. In this case, the CPU 30 acquires the program from the external electronic computer and executes the program.

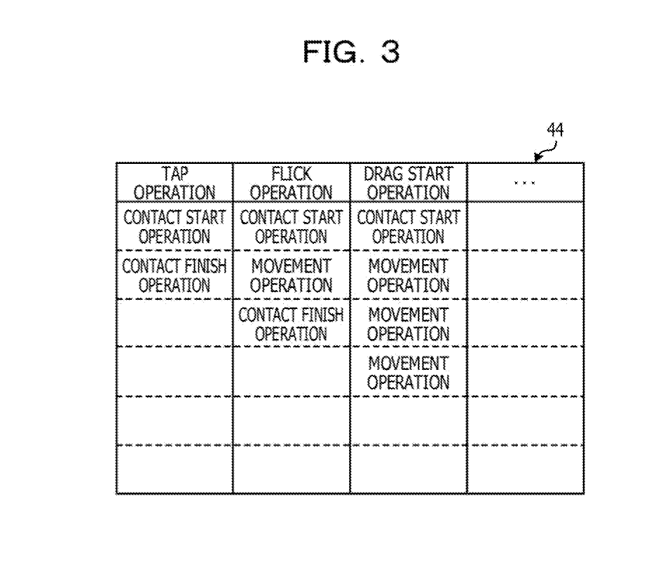

The applied operation table 44 is a table for deriving applied operation information from basic operation information. As depicted in FIG. 3 as an example, in the applied operation table 44, applied operation information is associated with different combinations of basic operation information (combinations that are predetermined in accordance with applied operations). In the example depicted in FIG. 3, contact start operation information (basic operation information) indicating a contact start operation and contact finish operation information (basic operation information) indicating a contact finish operation are associated, in the order in which they are generated, with tap operation information. Furthermore, in the example depicted in FIG. 3, contact start operation information, movement operation information (basic operation information) indicating a movement operation, and contact finish operation information are associated, in the order in which they are generated, with flick operation information. Furthermore, in the example depicted in FIG. 3, contact start operation information and three items of movement operation information are associated, in the order in which they are generated, with DG start operation information. In this way, the applied operation information is defined in accordance with basic operation information.

Returning to FIG. 2, the smart device 10 includes an external interface (I/F) 46 and is connected to the bus 36. The external I/F 46 is connected to an external device (for example, a personal computer or a USB memory), and manages the reception and transmission of various information between the external device and the CPU 30.

The smart device 10 includes a touch panel display 48. The touch panel display 48 is provided with a touch panel 12 and a display (for example, a liquid crystal display) 50. The display 50 is connected to the bus 36, and displays, under the control of the CPU 30, a variety of information. The touch panel 12 is, for example, an electrostatic capacitance-type touch panel, and includes a touch panel main body 52. The touch panel main body 52 has an electrode pattern that is laid out in the form of a mesh, and, by detecting changes in the electrostatic capacitance of the electrodes, detects that an indicating body (an electrically conductive indicating body such as a human finger) has come into contact with the touch panel 12. The touch panel main body 52 is connected to the bus 36, and outputs detection result information to the CPU 30. It ought to be noted that the position detection method employed by the touch panel 12 is not restricted to the electrostatic capacitance method, and may be another position detection method such as the matrix switch method, the resistive film method, the surface acoustic wave method, the infrared method, or the electromagnetic induction method.

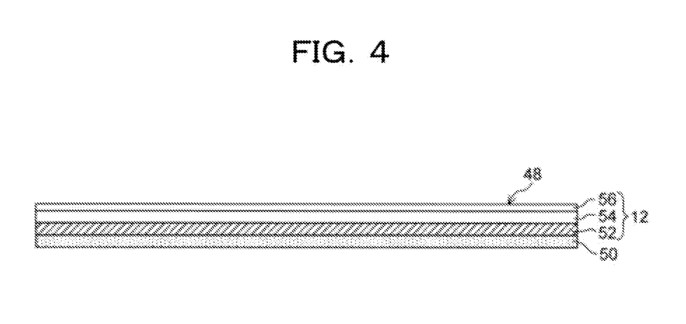

As depicted in FIG. 4 as an example, the touch panel 12 includes the touch panel main body 52, a glass sheet 54, and a film 56, each being translucent. The touch panel main body 52 is overlaid on the front surface of the display 50, and the glass sheet 54 is overlaid in contact with the touch panel main body 52. Furthermore, the film 56 is attached to the front surface of the glass sheet 54. The film 56 refers to, for example, a film for stopping other people from seeing the content displayed on the display 50 (for stopping shoulder hacking). Furthermore, the glass sheet 54 and the film 56 are both formed of a material and with a thickness that do not hinder the detection performed by the touch panel main body 52. Therefore, if the indicating body comes into contact at a location where the film 56 and the glass sheet 54 are adhered, this contact is detected by the touch panel main body 52. Conversely, if the indicating body comes into contact at a location where the film 56 and the glass sheet 54 are not adhered (for example, a location where an air bubble is included (an air bubble-containing location)), this contact is not detected by the touch panel main body 52. Therefore, there are cases where a non-detection period is generated by the touch panel 12 when the indicating body passes over an air bubble-containing location during a slide operation.

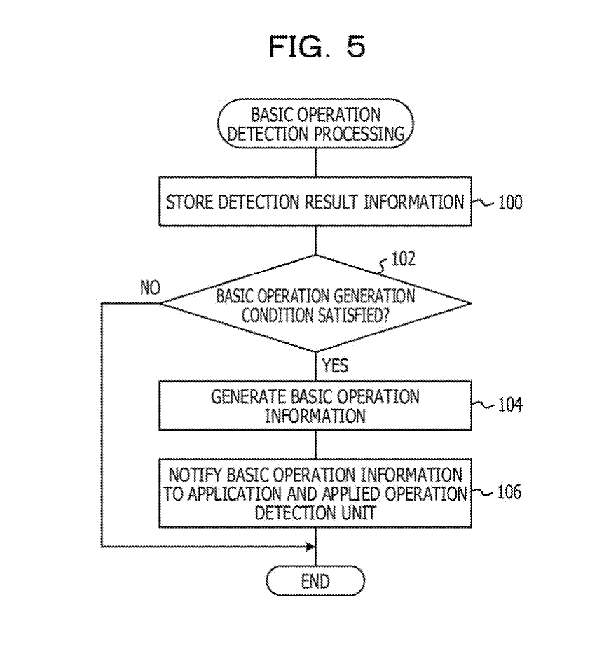

The operation of the present first embodiment is described next. First, basic operation detection processing performed by the smart device 10 using the CPU 30 executing the basic operation detection program 38 each time detection result information is input to the CPU 30 from the touch panel 12 is described with reference to the flowchart depicted in FIG. 5. It ought to be noted that, hereafter, for convenience of explanation, an explanation is provided for the case where the smart device 10 is able to detect a plurality of single operations and a single multiple operation performed in parallel on the touch panel 12, and is not able to detect a plurality of multiple operation that have been performed in parallel on the touch panel 12. Furthermore, hereafter, for convenience of explanation, an explanation is provided for the case where the CPU 30 is executing the application 18 in parallel with the execution of the basic operation detection program 38. Furthermore, hereafter, for convenience of explanation, an explanation is provided in which a tap operation is given as an example of a single operation, and a drag operation is given as an example of a multiple operation.

In the basic operation detection processing depicted in FIG. 5, first, in step 100, the basic operation detection unit 20 stores detection result information in the detection result storage region 32A in a time-sequential manner, and, thereafter, processing moves to step 102.

In step 102, the basic operation detection unit 20 determines whether or not a condition for generating basic operation information (basic operation generation condition) has been satisfied. The basic operation generation condition refers to, for example, the condition that there is sufficient detection result information stored in the detection result storage region 32A to generate any of the basic operation information of contact start operation information, movement operation information, and contact finish operation information.

In step 102, if the basic operation generation condition has been satisfied, the determination is positive, and processing moves to step 104. In step 102, if the basic operation generation condition has not been satisfied, the determination is negative, and the basic operation detection processing is finished.

In step 104, the basic operation detection unit 20 generates basic operation information corresponding to the detection result information stored in the detection result storage region 32A, and, thereafter, processing moves to step 106.

In step 106, the basic operation detection unit 20 notifies the basic operation information generated in step 104 to the application 18 and the applied operation detection unit 22, and, thereafter, the basic operation detection processing is finished.

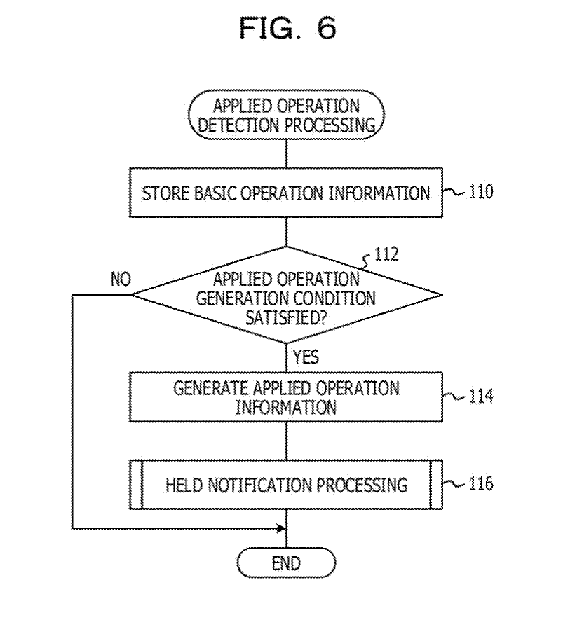

Next, applied operation detection processing performed by the smart device 10 using the CPU 30 executing the applied operation detection program 40 each time basic operation information is notified from the basic operation detection unit 20 to the applied operation detection unit 22 is described with reference to FIG. 6. It ought to be noted that, in the applied operation detection processing, flick operation information and double-tap operation information are processed in the same manner as tap operation information. Furthermore, PO start information, PC start information, and LP start information are processed in the same manner as DG start information. In addition, PO finish information, PC finish information, and LP finish information are processed in the same manner as DG finish information. Therefore, hereafter, for convenience of explanation, an explanation is provided in which tap operation information, DG start information, DG movement operation, and DG finish information are given as examples of applied operation information according to the disclosed technology, and an explanation regarding applied operation information other than these is omitted. Furthermore, hereafter, for convenience of explanation, an explanation is provided for the case where the CPU 30 is executing the application 18 in parallel with the execution of the applied operation detection program 40.

In the applied operation detection processing depicted in FIG. 6, first, in step 110, the applied operation detection unit 22 stores basic operation information notified from the basic operation detection unit 20 in the basic operation storage region 32B in a time-sequential manner, and, thereafter, processing moves to step 112.

In step 112, the applied operation detection unit 22 determines whether or not a condition for generating applied operation information (applied operation generation condition) has been satisfied. The applied operation generation condition refers to, for example, the condition that there is sufficient basic operation information stored in the basic operation storage region 32B to generate any of the applied operation information stored in the applied operation table 44 depicted in FIG. 3.

In step 112, if the applied operation generation condition has been satisfied, the determination is positive, and processing moves to step 114. In step 112, if the applied operation generation condition has not been satisfied, the determination is negative, and the applied operation detection processing is finished.

In step 114, the held notification unit 24 generates applied operation information corresponding to the basic operation information stored in the basic operation storage region 32B, and, thereafter, processing moves to step 116.

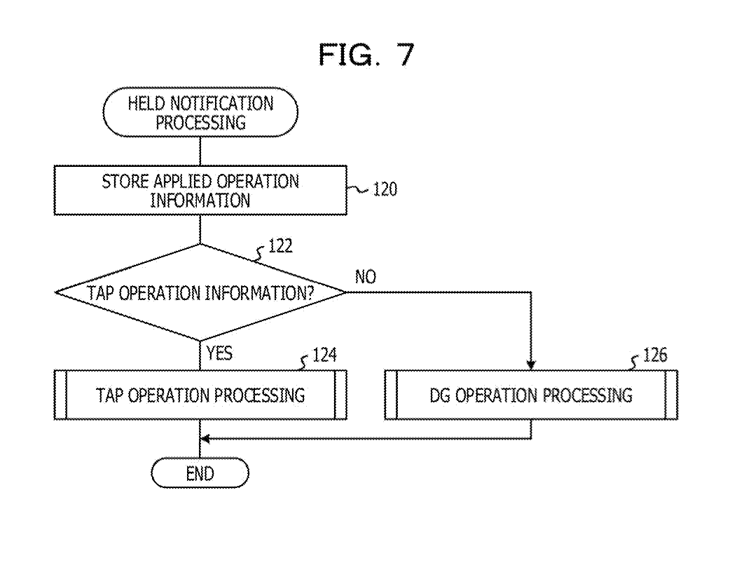

In step 116, the held notification unit 24 executes the held notification processing depicted in FIG. 7 as an example, and, thereafter, the applied operation detection processing is finished.

In the held notification processing depicted in FIG. 7, first, in step 120, the held notification unit 24 stores the applied operation information generated in step 114 in the applied operation storage region 32C, and, thereafter, processing moves to step 122.

In step 122, the held notification unit 24 determines whether or not the applied operation information stored in the applied operation storage region 32C is tap operation information. In step 122, if the applied operation information stored in the applied operation storage region 32C is tap operation information, the determination is positive, and processing moves to step 124. In step 122, if the applied operation information stored in the applied operation storage region 32C is not tap operation information (in the case of any of DG start information, DG movement information, and DG finish information), the determination is negative, and processing moves to step 126.

In step 124, the held notification unit 24 executes the tap operation processing depicted in FIG. 8 as an example, and, thereafter, the held notification processing is finished.

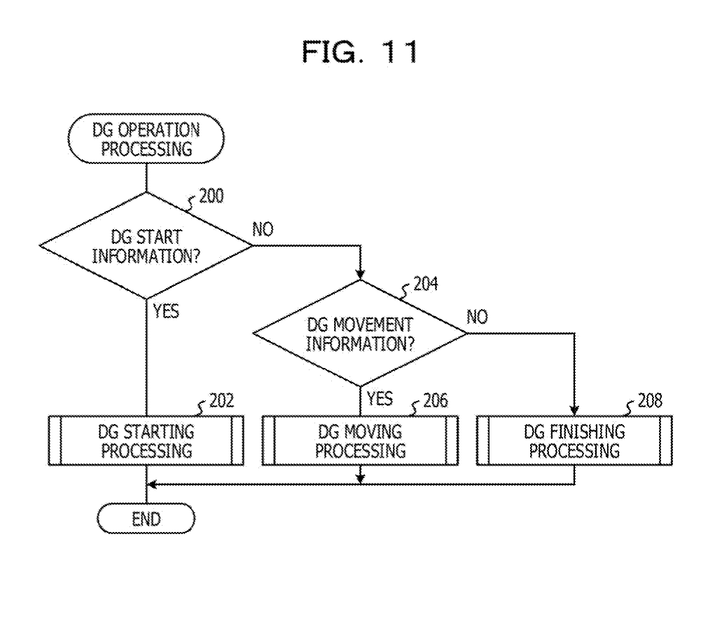

In step 126, the held notification unit 24 executes the drag operation processing (DG operation processing) depicted in FIG. 11 as an example, and, thereafter, the held notification processing is finished.

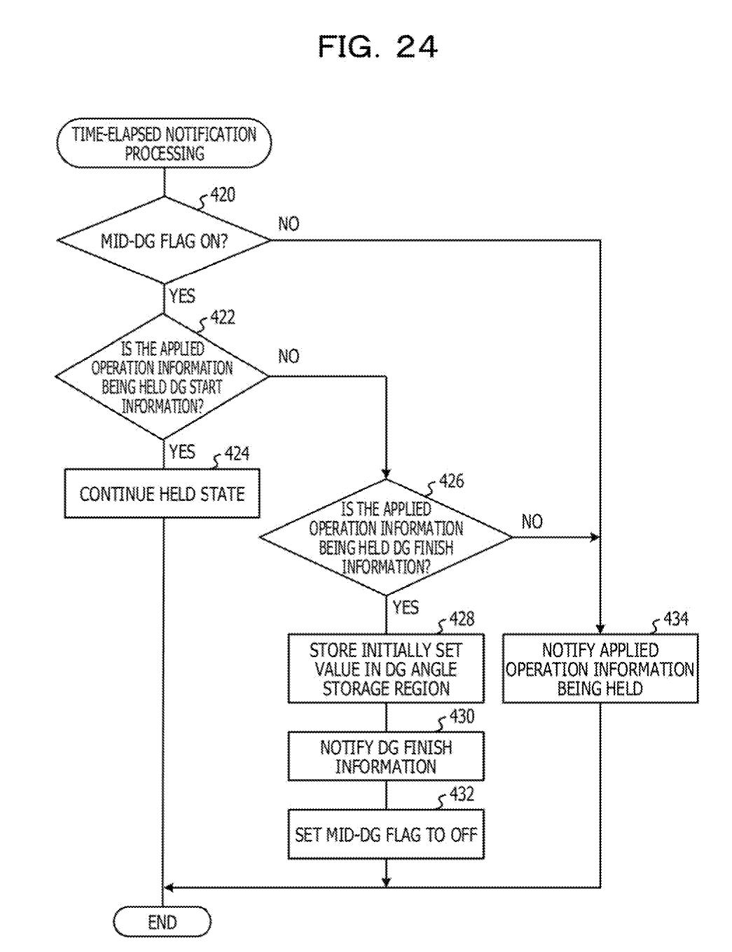

In the tap operation processing depicted in FIG. 8, first, in step 130, the held notification unit 24 determines whether or not a mid-drag flag (mid-DG flag), which indicates that a drag operation is being performed, is on. Here, the mid-DG flag being on means that DG start information or DG finish information is being held. It ought to be noted that the mid-DG flag is on in step 230 (see FIG. 12) and step 268 (see FIG. 15) described hereafter, and is off in step 432 (see FIG. 24) described hereafter.

In step 130, if the mid-DG flag is on, the determination is positive, and processing moves to step 132. In step 130, if the mid-DG flag is off, the determination is negative, and processing moves to step 147.

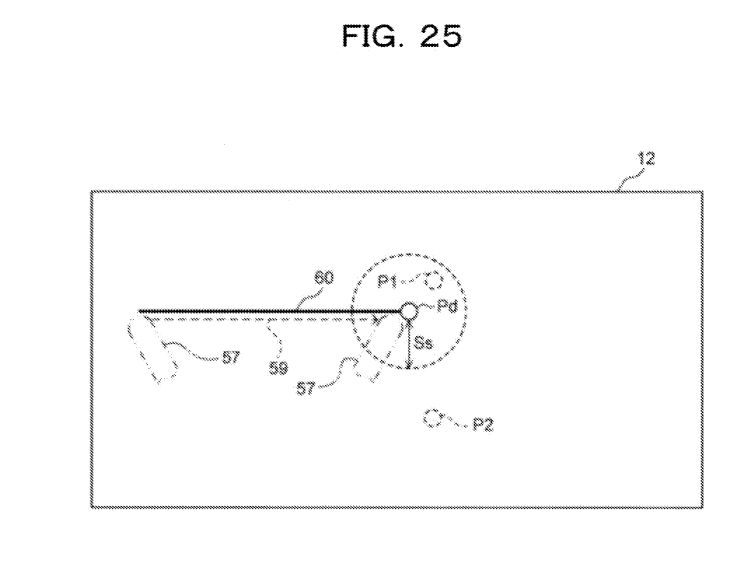

In step 132, the held notification unit 24 calculates an inter-operation distance from coordinates (hereafter referred to as the “latest coordinates”) included in applied operation information stored in the applied operation storage region 32C and DG position coordinates stored in the DG coordinates storage region 32G. In step 132, the inter-operation distance means an example of a positional interval in the disclosed technology, and refers to the distance between the latest coordinates and the DG position coordinates. Furthermore, as depicted in FIG. 25 as an example, the DG position coordinates refer to the coordinates of a finish position Pd of a DG locus 60 that indicates the locus of a drag operation 59 (an example of a preceding slide operation in the disclosed technology) performed by an indicating body 57 on the touch panel 12. Furthermore, in the example depicted in FIG. 25, the coordinates of position P1 or P2 of tap operations performed on the touch panel 12 correspond to the latest coordinates in step 132.

In the following step 134, the held notification unit 24 determines whether or not the inter-operation distance calculated in step 132 is less than a first predetermined value (for example, 5 millimeters), which is an example of the third threshold value and the sixth threshold value in the disclosed technology. As depicted in FIG. 25 as an example, the inter-operation distance being less than the first predetermined value means that the position of a tap operation is present inside a circle having a radius Ss that is centered on the finish position Pd.

It ought to be noted that it is also feasible for the first predetermined value to be a variable value. For example, it is possible to further increase the degree of certainty of the determination by calculating, from the speed at which the DG locus is traced, a coordinate at which contact is presumed to be made when it is assumed that the DG locus has moved at a uniform speed, and by using the distance between that coordinate and the finish position Pd as the first predetermined value.

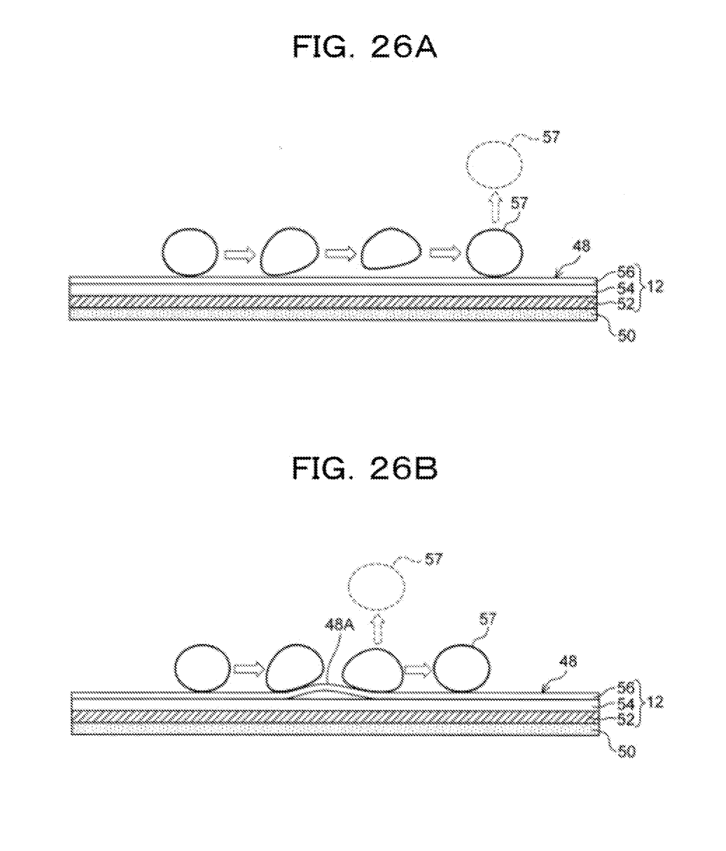

A possible example of the case where the position of a tap operation is present inside a circle having a radius Ss is, as depicted in FIG. 26A for example, the case where a tap operation is performed within the circle having the radius Ss after the indicating body 57 has caught on the film 56 during a drag operation and momentarily separated from the touch panel 12. Furthermore, as depicted in FIG. 26B for example, another possible example is the case where a tap operation is performed inside the circle having the radius Ss after the indicating body 57 has momentarily separated from the touch panel 12 due to the indicating body 57 moving over an air bubble-containing location 48A during a drag operation. It ought to be noted that the case where a drag operation is interrupted and a tap operation is performed is indicated in the example depicted in FIG. 26A, and the case where a drag operation is interrupted and a tap operation is performed and the case where a drag operation is started once again after the drag operation has been interrupted are indicated in the example depicted in FIG. 26B.

In step 134, if the inter-operation distance calculated in step 132 is less than the first predetermined value (in the example depicted in FIG. 25, if the latest coordinates are the coordinates of position P1), the determination is positive, and processing moves to step 136. In step 134, if the inter-operation distance calculated in step 132 is equal to or greater than the first predetermined value (in the example depicted in FIG. 25, if the latest coordinates are the coordinates of position P2), the determination is negative, and processing moves to step 146.

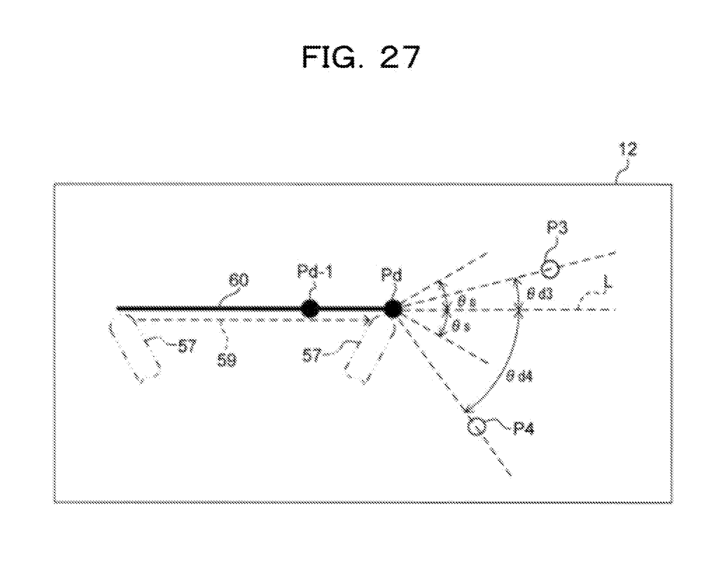

In step 136, the held notification unit 24 calculates an inter-operation angle from the latest coordinates and DG position coordinates stored in the DG coordinates storage region 32G, and stores (overwrites and saves) the calculated inter-operation angle in the inter-operation angle storage region 32E, and, thereafter, processing moves to step 138. In step 136, the inter-operation angle means an example of an angle that defines the inter-operation direction in the disclosed technology, and refers to the angle formed between the line segment joining the latest coordinates and DG position coordinates, and the angle (0 degrees as an example here) of a reference line L (see FIG. 27) on the touch panel 12. For example, as depicted in FIG. 27, in the case where the coordinates of the position P3 (P4) of a tap operation performed on the touch panel 12 are used as the latest coordinates, angle θd3 (θd4) formed between the line segment joining the finish position Pd and position P3 (P4) and the reference line L is the inter-operation angle. The reference line L refers to, for example, an X-axis that defines coordinates that specify the contact position of the indicating body on the touch panel 12.

In step 138, the held notification unit 24 calculates the angle difference (an example of the first angle in the disclosed technology) between a DG direction angle stored in the DG angle storage region 32F and the inter-operation angle stored in the inter-operation angle storage region 32E, and, thereafter, processing moves to step 140. The DG direction angle is, for example, stored in the DG angle storage region 32F in step 170 (see FIG. 9), in step 300 (see FIG. 17), and in step 312 (see FIG. 18) and so forth described hereafter. Here, the DG direction angle means an example of an angle that defines the finishing slide direction in the disclosed technology, and, for example, as disclosed in FIG. 27, refers to the angle (0 degrees in the example depicted in FIG. 27) formed between the reference line L and the line extending from the line segment joining position Pd−1 on the DG locus 60 and the finish position Pd. Position Pd−1 refers to a position specified by coordinates included in applied operation information (for example, DG operation information) generated by the applied operation detection processing performed immediately prior to the DG finish information being generated by applied operation detection processing at the finish position Pd. In step 138, the angle difference refers to the absolute value of the difference between the DG direction angle (0 degrees in the example depicted in FIG. 27) and the inter-operation angle (angle θd3 or θd4 in the example depicted in FIG. 27).

In step 140, the held notification unit 24 determines whether or not the angle difference calculated in step 138 is less than a second predetermined value (an example of the first threshold value and the fourth threshold value in the disclosed technology). The second predetermined value, for example, means 45 degrees, and refers to angle θs in the example depicted in FIG. 27. In step 140, if the angle difference calculated in step 138 is less than the second predetermined value, the determination is positive, and processing moves to step 142. In step 140, if the angle difference calculated in step 138 is equal to or greater than the second predetermined value, the determination is negative, and processing moves to step 146.

In step 142, the held notification unit 24 determines whether or not there is applied operation information being held. The applied operation information being held means applied operation information for which notification to the application 18 is being held, and refers to applied operation information currently stored in the holding operation storage region 32D.

In step 142, if there is applied operation information being held, the determination is positive, and processing moves to step 144. In step 142, if there is no applied operation information being held, the determination is negative, and processing moves to step 150.

In step 144, the held notification unit 24 executes the mid-holding processing depicted in FIG. 9 as an example, and, thereafter, the tap operation processing is finished.

In step 146, the held notification unit 24 notifies the tap operation information stored in the applied operation storage region 32C to the application 18, and also deletes the tap operation information from the applied operation storage region 32C, and, thereafter, the tap operation processing is finished.

In step 147, the held notification unit 24 determines whether or not a timer (depiction omitted) is operating. It ought to be noted that a timer is activated in step 152, step 176 (see FIG. 9), step 246 (see FIG. 13), step 306 (see FIG. 17), step 328 (see FIG. 18), and step 350 (see FIG. 19) described hereafter. While the applied operation information is stored in the holding operation storage region 32D, if a reference time Ts described hereafter has elapsed from the timer being activated, time-elapsed notification processing (see FIG. 24) described hereafter is performed by the time-elapsed notification unit 26.

In step 147, if the timer is operating, the determination is positive, and processing moves to step 148. In step 147, if the timer is not operating, the determination is negative, and processing moves to step 150.

In step 148, the held notification unit 24 determines whether or not the reference time Ts (for example, 500 milliseconds), which is an example of the second threshold value, the fifth threshold value, and the predetermined time in the disclosed technology, has elapsed from the timer being activated. In step 148, if the reference time Ts has elapsed from the timer being activated, the determination is positive, and processing moves to step 149. In step 148, if the reference time Ts has not elapsed from the timer being activated, the determination is negative, and processing moves to step 154.

In step 149, the held notification unit 24 stops the timer, and, thereafter, processing moves to step 150.

In step 150, the held notification unit 24 holds the notification of the tap operation information to the application 18, and, thereafter, processing moves to step 152. It ought to be noted that the holding of the notification of the tap operation information to the application 18 is realized by the tap operation information stored in the applied operation storage region 32C being stored in the holding operation storage region 32D, and also the tap operation information being deleted from the applied operation storage region 32C.

In step 152, the held notification unit 24 activates the timer, and, thereafter, the tap operation processing is finished.

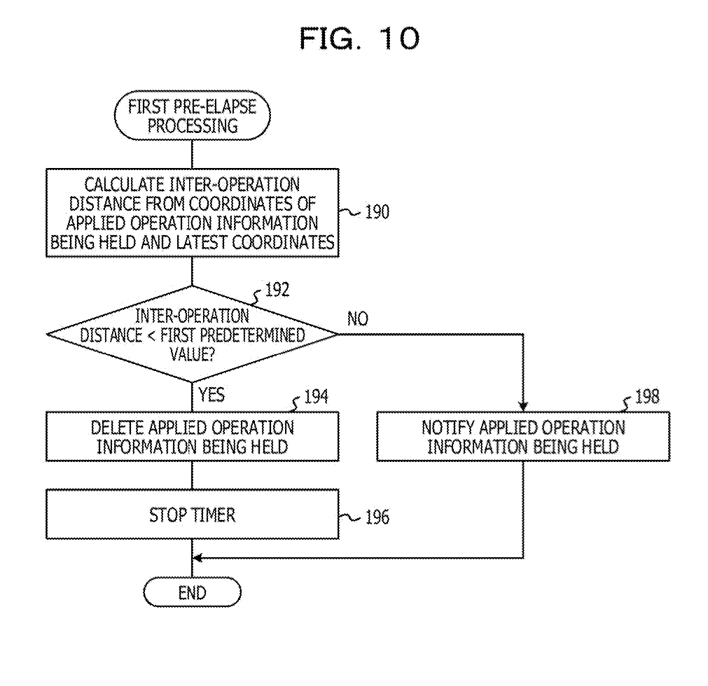

In step 154, the held notification unit 24 executes the first pre-elapse processing depicted in FIG. 10 as an example, and, thereafter, processing moves to step 150.

In the mid-holding processing depicted in FIG. 9, first, in step 160, the held notification unit 24 determines whether or not the applied operation information being held is DG start information. In step 160, if the applied operation information being held is DG start information, the determination is positive, and processing moves to step 162. It ought to be noted that the held state of DG start information is, for example, released by second finishing processing (FIG. 18) or second moving processing (FIG. 22) being performed by the held notification unit 24.

If the determination is positive in step 160, there is a possibility that the tap operation indicated by the tap operation information constituting the applied operation information currently stored in the applied operation storage region 32C is not a tap operation that has been performed with a non-detection period interposed. In other words, there is a possibility that, while a drag start operation is being performed by one indicating body from among two indicating bodies (for example, the index finger of the left hand and the index finger of the right hand), a tap operation has been performed by the other indicating body (a possibility that a tap operation has been detected in parallel with a drag operation). In this case, the tap operation performed by the other indicating body may or may not be deemed to be an erroneous operation; however, in the present first embodiment, for convenience of explanation, this is deemed to be an erroneous operation.

Thus, in step 162, the held notification unit 24 deletes, from the applied operation storage region 32C, the tap operation information constituting the applied operation information currently stored in the applied operation storage region 32C, and, thereafter, the mid-holding processing is finished. It ought to be noted that, if the tap operation indicated by the tap operation information to be deleted in step 162 is not deemed to be an erroneous operation, it is permissible for the held notification unit 24 to notify the application 18 without the tap operation information being deleted in step 162.

In step 160, if the applied operation information being held is not DG start information, the determination is negative, and processing moves to step 164. If the determination is negative in step 160, it is deemed that there is a possibility that a tap operation has been performed due to the indicating body having caught on the film 56 during a slide operation (see FIG. 26A) or due to the indicating body having moved over an air bubble-containing location 48A (see FIG. 26B).

Thus, first, in step 164, the held notification unit 24 determines whether or not the applied operation information being held is DG finish information. In step 164, if the applied operation information being held is DG finish information, the determination is positive (it is determined that the drag finish operation indicated by the DG finish information being held is an erroneous operation), and processing moves to step 166. In step 164, if the applied operation information being held is not DG finish information, the determination is negative (it is determined that the applied operation (a tap operation as an example here) indicated by the applied operation information being held is an erroneous operation), and processing moves to step 178.

In step 166, the held notification unit 24 stops the timer, and, thereafter, processing moves to step 168.

In step 168, the held notification unit 24 notifies, to the application 18, the DG movement information having coordinates (in the example depicted in FIG. 27, coordinates included in the DG finish information being held relating to the finish position Pd) included in the DG finish information constituting the applied operation information being held. In this way, by the processing of step 168 being performed, the application 18 is notified that the drag operation is still continuing (part of the preceding drag operation).

In the following step 170, the held notification unit 24 calculates the DG direction angle from the latest coordinates and the coordinates included in the DG finish information constituting the applied operation information being held and stores (overwrites and saves) the DG direction angle in the DG angle storage region 32F, and, thereafter, processing moves to step 172.

In step 172, the held notification unit 24 stores (overwrites and saves), in the DG coordinates storage region 32G, the coordinates included the DG finish information constituting the applied operation information being held, and, thereafter, processing moves to step 174.

In step 174, the held notification unit 24 updates, to the latest coordinates, the coordinates included in the DG finish information constituting the applied operation information being held, and also deletes the tap operation information from the applied operation storage region 32C, and, thereafter, processing moves to step 176. It ought to be noted that the notification of the DG finish information to the application 18 continues to be held in step 174 because the drag finish operation indicated by this DG finish information may be an erroneous operation (it has not yet been established whether or not this is an erroneous operation).

In step 176, the held notification unit 24 activates the timer, and, thereafter, the mid-holding processing is finished.

In step 178, the held notification unit 24 stops the timer, and, thereafter, processing moves to step 180.

In step 180, the held notification unit 24 deletes the applied operation information being held from the holding operation storage region 32D, and, thereafter, processing moves to step 182.

In step 182, the held notification unit 24 holds the notification of the tap operation information to the application 18, and, thereafter, processing moves to step 176. It ought to be noted that the notification of the tap operation information to the application 18 is held in step 182 because the tap operation indicated by this tap operation information may be an erroneous operation (it has not yet been established whether or not this is an erroneous operation).

In the first pre-elapse processing indicated in FIG. 10, first, in step 190, the held notification unit 24 calculates the inter-operation distance from the coordinates included in the applied operation information being held and the latest coordinates, and, thereafter, processing moves to step 192. In step 190, the inter-operation distance means an example of a positional interval in the disclosed technology, and refers to the distance between the coordinates included in the applied operation information being held and the latest coordinates.

In step 192, the held notification unit 24 determines whether or not the inter-operation distance calculated in step 190 is less than the first predetermined value. In step 192, if the inter-operation distance calculated in step 190 is less than the first predetermined value, the determination is positive (it is determined that the applied operation indicated by the applied operation information being held is an erroneous operation), and processing moves to step 194. In step 192, if the inter-operation distance calculated in step 190 is equal to or greater than the first predetermined value, the determination is negative (it is determined that the applied operation indicated by the applied operation information being held is not an erroneous operation), and processing moves to step 198.

It ought to be noted that a possible example of a case where the determination is positive in step 192 is the case where, although the user intended to perform a drag operation on the touch panel 12, a tap operation is actually detected due the indicating body momentarily separating from the touch panel 12. Specifically, a possible example is the case where, although the user intended to perform a drag operation on the touch panel 12, the indicating body catches several times on the touch panel 12 and the touch operations on the touch panel 12 are detected as a plurality of tap operations. Another possible example is the case where, although the user intended to perform a drag operation on the touch panel 12, the touch operations on the touch panel 12 are detected as a plurality of tap operations due to there being a plurality of air bubble-containing locations 48A (see FIG. 26B) on the movement path of the indicating body.

In step 194, the held notification unit 24 deletes the applied operation information being held from the holding operation storage region 32D, and, thereafter, processing moves to step 196.

In step 196, the held notification unit 24 stops the timer, and, thereafter, the first pre-elapse processing is finished.

In step 198, the held notification unit 24 notifies the applied operation information being held to the application 18, and also deletes the applied operation information from the holding operation storage region 32D, and, thereafter, the first pre-elapse processing is finished.

In the DG operation processing depicted in FIG. 11, first, in step 200, the held notification unit 24 determines whether or not the applied operation information stored in the applied operation storage region 32C is DG start information. In step 200, if the applied operation information stored in the applied operation storage region 32C is DG start information, the determination is positive, and processing moves to step 202. In step 200, if the applied operation information stored in the applied operation storage region 32C is not DG start information, the determination is negative, and processing moves to step 204.

In step 202, the held notification unit 24 executes the drag starting processing (DG starting processing) depicted in FIG. 12 as an example, and, thereafter, the DG operation processing is finished.

In step 204, the held notification unit 24 determines whether or not the applied operation information stored in the applied operation storage region 32C is DG movement information. In step 204, if the applied operation information stored in the applied operation storage region 32C is DG movement information, the determination is positive, and processing moves to step 206. In step 204, if the applied operation information stored in the applied operation storage region 32C is not DG movement information, the determination is negative, and processing moves to step 208.

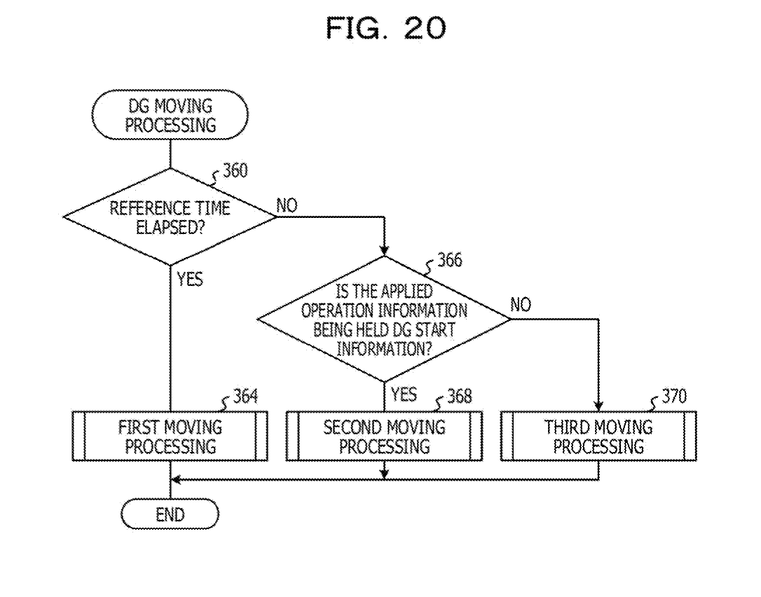

In step 206, the held notification unit 24 executes the drag moving processing (DG moving processing) depicted in FIG. 20 as an example, and, thereafter, the DG operation processing is finished.

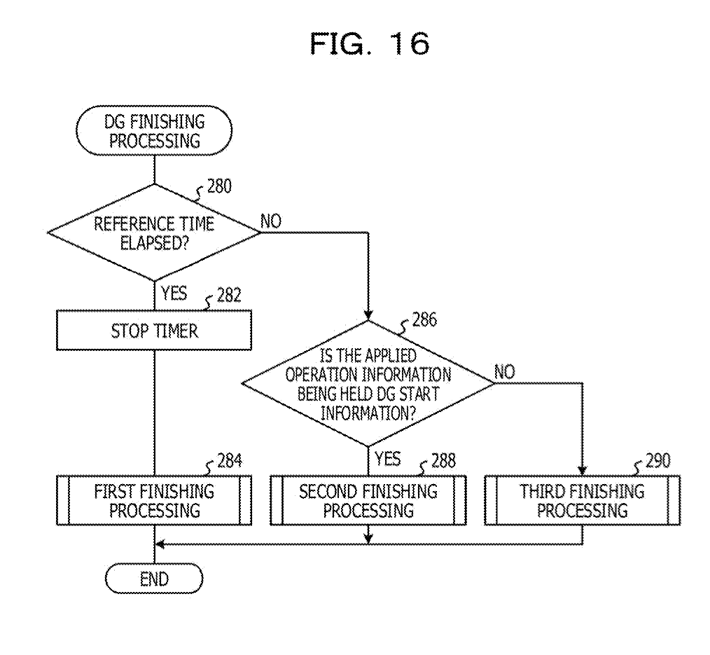

In step 208, the held notification unit 24 executes the drag finishing processing (DG finishing processing) depicted in FIG. 16 as an example, and, thereafter, the DG operation processing is finished.

In the DG starting processing depicted in FIG. 12, first, in step 210, the held notification unit 24 determines whether or not the mid-DG flag is on. In step 210, if the mid-DG flag is on, the determination is positive, and processing moves to step 212. In step 210, if the mid-DG flag is off, the determination is negative, and processing moves to step 226.

In step 212, the held notification unit 24 calculates the inter-operation distance from the latest coordinates and the DG position coordinates stored in the DG coordinates storage region 32G, and, thereafter, processing moves to step 214.

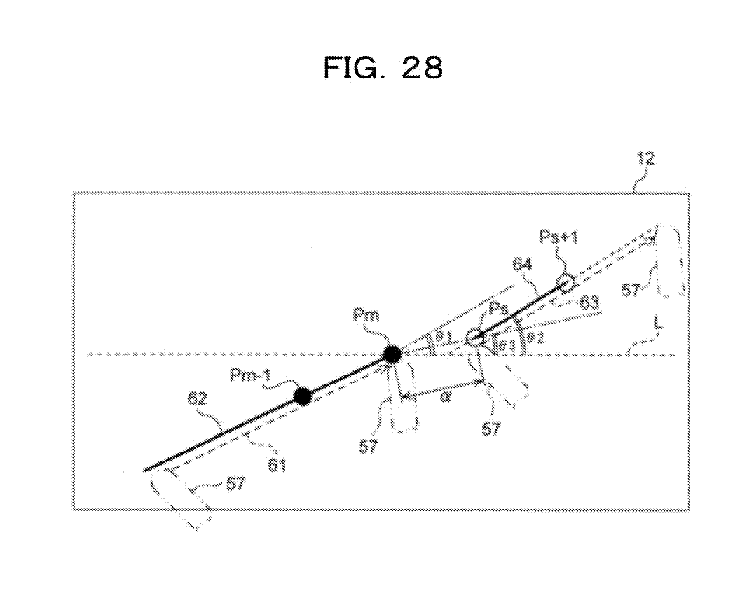

In step 212, the inter-operation distance means an example of a positional interval in the disclosed technology, and refers to the distance between the latest coordinates and DG position coordinates. In the example depicted in FIG. 28, the coordinates of the finish position Pm of a first DG locus 62 correspond to the DG position coordinates, and the coordinates of the start position Ps of a second DG locus 64 correspond to the latest coordinates. Therefore, in the example depicted in FIG. 28, the distance a between the coordinates of the finish position Pm of the first DG locus 62 and the coordinates of the start position Ps of the second DG locus 64 corresponds to the inter-operation distance in step 212. Here, the first DG locus 62 refers to the locus of a first drag operation 61 (an example of a preceding slide operation in the disclosed technology) on the touch panel 12. Furthermore, the second DG locus 64 refers to the locus of a second drag operation 63 (an example of a succeeding slide operation in the disclosed technology) that is performed in continuation from the first drag operation 61 with a non-detection period (a period during which detection of the indicating body 57 on the touch panel 12 is not detected) of the touch panel 12 therebetween.

In step 214, if the inter-operation distance calculated in step 212 by the held notification unit 24 is less than the first predetermined value, the determination is positive, and processing moves to step 216. In step 214, if the inter-operation distance calculated in step 212 is equal to or greater than the first predetermined value, the determination is negative, and processing moves to step 224.

In step 216, the held notification unit 24 calculates an inter-operation angle from the latest coordinates and DG position coordinates stored in the DG coordinates storage region 32G, and stores (overwrites and saves) the calculated inter-operation angle in the inter-operation angle storage region 32E, and, thereafter, processing moves to step 218. In step 216, the inter-operation angle, for example, as depicted in FIG. 28, refers to angle θ3 formed between the reference line L and the line segment joining the finish position Pm and the start position Ps.

In step 218, the held notification unit 24 calculates the angle difference between a DG direction angle stored in the DG angle storage region 32F and the inter-operation angle stored in the inter-operation angle storage region 32E, and, thereafter, processing moves to step 220.

In the example depicted in FIG. 28, the DG direction angle refers to the angle θ1 or θ2. Angle θ1 is the angle formed between the reference line L and the line extending from the line segment joining position Pm−1 on the first DG locus 62 and the finish position Pm, and angle θ2 is the angle formed between the reference line L and the line segment joining the start position Ps and position Ps+1 on the second DG operation 64. Position Pm−1 refers to a position specified by coordinates included in applied operation information (for example, DG movement information) generated by the applied operation detection processing performed immediately prior to the DG finish information being generated by applied operation processing at the finish position Pm. Position Ps+1 refers to a position specified by coordinates included in applied operation information (for example, DG movement information) generated by the applied operation detection processing performed immediately following the DG start information being generated by applied operation processing at the start position Ps. Furthermore, in the example depicted in FIG. 28, the angle difference in step 218 refers to, for example, the absolute value of the difference between angle θ1 and angle θ3.

In step 220, the held notification unit 24 determines whether or not the angle difference calculated in step 218 is less than the second predetermined value. In step 220, if the angle difference calculated in step 218 is less than the second predetermined value, the determination is positive (it is determined that the applied operation indicated by the applied operation information being held is an erroneous operation), and processing moves to step 222. In step 220, if the angle difference calculated in step 218 is equal to or greater than the second predetermined value, the determination is negative (it is determined that the applied operation indicated by the applied operation information being held is not an erroneous operation), and processing moves to step 224.

In step 222, the held notification unit 24 executes the erroneous operation response processing depicted in FIG. 13 as an example, and, thereafter, the DG starting processing is finished.

In step 224, the held notification unit 24 executes the correct operation response processing depicted in FIG. 14 as an example, and, thereafter, the DG starting processing is finished.

In step 226, the held notification unit 24 determines whether or not the timer is operating. In step 226, if the timer is operating, the determination is positive, and processing moves to step 228. In step 226, if the timer is not operating, the determination is negative, and processing moves to step 230.

In step 228, the held notification unit 24 determines whether or not the reference time Ts has elapsed from the timer being activated. In step 228, if the reference time Ts has elapsed from the timer being activated, the determination is positive, and processing moves to step 230. In step 228, if the reference time Ts has not elapsed from the timer being activated, the determination is negative, and processing moves to step 236.

In step 230, the held notification unit 24 sets the mid-DG flag to on, and, thereafter, processing moves to step 232.

In step 232, the held notification unit 24 stores (overwrites and saves) the coordinates of the DG start information stored in the applied operation storage region 32C, in the DG coordinates storage region 32G as the DG position coordinates, and, thereafter, processing moves to step 234.

In step 234, the held notification unit 24 notifies the DG start information stored in the applied operation storage region 32C to the application 18, and also deletes the DG start information from the applied operation storage region 32C, and, thereafter, the DG starting processing is finished.

In step 236, the held notification unit 24 executes the second pre-elapse processing depicted in FIG. 15 as an example, and, thereafter, the DG starting processing is finished.

In the erroneous operation response processing depicted in FIG. 13, in step 240, the held notification unit 24 notifies, to the application 18, the DG movement information having coordinates (in the example depicted in FIG. 28, coordinates included in the DG finish information being held relating to the finish position Pm) included in the applied operation information being held. In this way, by the processing of step 240 being performed, the application 18 is notified that the drag operation is still continuing (that the operation at the start position Ps depicted in FIG. 28 as an example is part of the first drag operation 61).

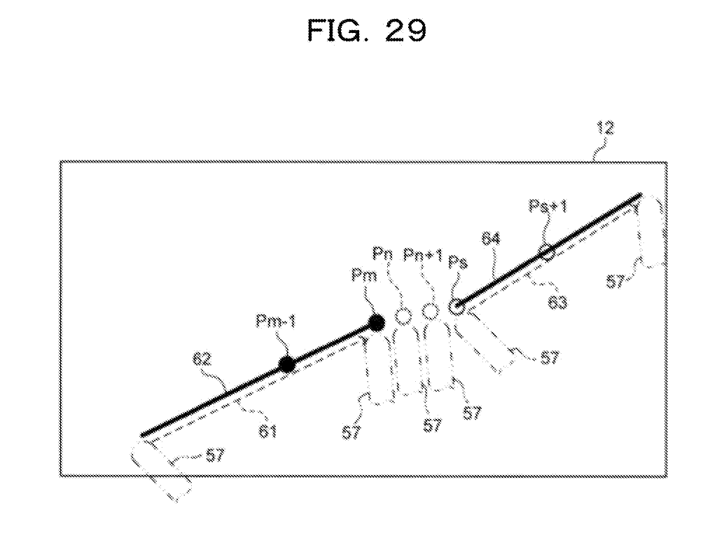

Furthermore, as depicted in FIG. 29 as an example, if tap operations are performed in order at position Pn and position Pn+1 on the line segment joining the finish position Pm and the start position Ps, the DG movement information is notified to the application 18 by the processing of step 168 depicted in FIG. 9 being performed. In this case, because the DG finish information having the coordinates of position Pn+1 is held as applied operation information (see step 174 in FIG. 9), in step 240, the DG movement information having the coordinates of position Pn+1 is notified to the application 18.

In the following step 242, the held notification unit 24 stores (overwrites and saves) the coordinates of the DG start information stored in the applied operation storage region 32C, in the DG coordinates storage region 32G as the DG position coordinates, and, thereafter, processing moves to step 244.

In step 244, the held notification unit 24 holds the notification of the DG start information to the application 18, and, thereafter, processing moves to step 246. It ought to be noted that the holding of the notification of the DG start information to the application 18 is realized by the DG start information stored in the applied operation storage region 32C being stored in the holding operation storage region 32D, and also the DG start information being deleted from the applied operation storage region 32C.

In step 246, the held notification unit 24 activates the timer, and, thereafter, the erroneous operation response processing is finished.

In the correct operation response processing depicted in FIG. 14, first, in step 250, the held notification unit 24 notifies, to the application 18, the DG finish information having coordinates included in the applied operation information being held (for example, DG start information or DG finish information), and, thereafter, processing moves to step 252. In this way, by the processing of step 250 being performed, the DG finish information relating to the finish position Pm depicted in FIG. 28 as an example is notified to the application 18.

In step 252, the held notification unit 24 deletes the applied operation information being held from the holding operation storage region 32D, and, thereafter, processing moves to step 254.

In step 254, the held notification unit 24 stores (overwrites and saves) the initially set value in the DG angle storage region 32F, and, thereafter, processing moves to step 256.

In step 256, the held notification unit 24 stores (overwrites and saves) the coordinates of the DG start information stored in the applied operation storage region 32C, in the DG coordinates storage region 32G as the DG position coordinates, and, thereafter, processing moves to step 258.

In step 258, the held notification unit 24 notifies the DG start information stored in the applied operation storage region 32C to the application 18, and also deletes the DG start information from the applied operation storage region 32C, and, thereafter, the correct operation response processing is finished. In this way, by the processing of step 258 being performed, the DG start information relating to the start position Ps depicted in FIG. 28 as an example is notified to the application 18.

In the second pre-elapse processing indicated in FIG. 15, first, in step 260, the held notification unit 24 calculates the inter-operation distance from the latest coordinates and the coordinates included in the applied operation information being held (tap operation information as an example here), and, thereafter, processing moves to step 262. In step 260, the inter-operation distance refers to the distance between the latest coordinates and the coordinates included in the applied operation information being held.

In step 262, the held notification unit 24 determines whether or not the inter-operation distance calculated in step 260 is less than the first predetermined value. In step 262, if the inter-operation distance calculated in step 260 is equal to or greater than the first predetermined value, the determination is negative (it is determined that the applied operation indicated by the applied operation information being held is not an erroneous operation), and processing moves to step 264. In step 262, if the inter-operation distance calculated in step 260 is less than the first predetermined value, the determination is positive (it is determined that the applied operation indicated by the applied operation information being held is an erroneous operation), and processing moves to step 266.

In step 264, the held notification unit 24 notifies the applied operation information being held to the application 18, and, thereafter, processing moves to step 266.

In step 266, the held notification unit 24 deletes the applied operation information being held from the holding operation storage region 32D, and, thereafter, processing moves to step 268.

In step 268, the held notification unit 24 sets the mid-DG flag to on, and, thereafter, processing moves to step 270.

In step 270, the held notification unit 24 stores (overwrites and saves) the coordinates of the DG start information stored in the applied operation storage region 32C, in the DG coordinates storage region 32G as the DG position coordinates, and, thereafter, processing moves to step 272.

In step 272, the held notification unit 24 notifies the DG start information stored in the applied operation storage region 32C to the application 18, and also deletes the DG start information from the applied operation storage region 32C, and, thereafter, the second pre-elapse processing is finished.

In the DG finishing processing depicted in FIG. 16, first, in step 280, the held notification unit 24 determines whether or not the reference time Ts has elapsed from the timer being activated. In step 280, if the reference time Ts has elapsed from the timer being activated, the determination is positive, and processing moves to step 282. In step 280, if the reference time Ts has not elapsed from the timer being activated, the determination is negative, and processing moves to step 286.

In step 282, the held notification unit 24 stops the timer, and, thereafter, processing moves to step 284.

In step 284, the held notification unit 24 executes the first finishing processing depicted in FIG. 17 as an example, and, thereafter, the DG finishing processing is finished.

In step 286, the held notification unit 24 determines whether or not the applied operation information being held is DG start information. In step 286, if the applied operation information being held is DG start information (in the example depicted in FIG. 28, if the DG start information relating to the start position Ps is being held), the determination is positive, and processing moves to step 288. In step 286, if the applied operation information being held is not DG start information (for example, if tap operation information is being held due to another indicating body having performed a tap operation during a drag operation (if the mid-DG flag is on)), the determination is negative, and processing moves to step 290.

In step 288, the held notification unit 24 executes the second finishing processing depicted in FIG. 18 as an example, and, thereafter, the DG finishing processing is finished.

In step 290, the held notification unit 24 executes the third finishing processing depicted in FIG. 19 as an example, and, thereafter, the DG finishing processing is finished.

In the first finishing processing depicted in FIG. 17, first, in step 300, the held notification unit 24 calculates the DG direction angle from the latest coordinates and the DG position coordinates stored in the DG coordinates storage region 32G, and stores (overwrites and saves) the DG direction angle in the DG angle storage region 32F. The DG direction angle calculated in step 300 refers to, for example, angle θ1 in the example depicted in FIG. 28.

In the following step 302, the held notification unit 24 stores (overwrites and saves) the coordinates of the DG finish information stored in the applied operation storage region 32C, in the DG coordinates storage region 32G as the DG position coordinates, and, thereafter, processing moves to step 304.

In step 304, the held notification unit 24 holds the notification of the DG finish information to the application 18, and, thereafter, processing moves to step 306. It ought to be noted that the holding of the notification of the DG finish information to the application 18 is realized by the DG finish information stored in the applied operation storage region 32C being stored in the holding operation storage region 32D, and also the DG finish information being deleted from the applied operation storage region 32C. Furthermore, the holding of the notification of the DG finish information to the application 18 refers to, for example, the holding of the notification, to the application 18, of the DG finish information relating to the finish position Pm depicted in FIG. 28.

In step 306, the held notification unit 24 activates the timer, and, thereafter, the first finishing processing is finished.

In the second finishing processing depicted in FIG. 18, first, in step 310, the held notification unit 24 stops the timer, and, thereafter, processing moves to step 312.

In step 312, the held notification unit 24 calculates the DG direction angle (angle θ2 in the example depicted in FIG. 28) from the latest coordinates and the DG position coordinates stored in the DG coordinates storage region 32G, and stores (overwrites and saves) the DG direction angle in the DG angle storage region 32F, and, thereafter, processing moves to step 314. It ought to be noted that the latest coordinates used in step 312, for example, refer to coordinates included in DG finish information generated at position Ps+1 in the case where the second drag operation 63 depicted in FIG. 28 is interrupted at position Ps+1.

In step 314, the held notification unit 24 calculates the angle difference (|θ2-θ3| in the example depicted in FIG. 28) between the DG direction angle stored in the DG angle storage region 32F and the inter-operation angle stored in the inter-operation angle storage region 32E, and, thereafter, processing moves to step 316.

In step 316, the held notification unit 24 determines whether or not the angle difference calculated in step 314 is less than the second predetermined value. In step 316, if the angle difference calculated in step 314 is equal to or greater than the second predetermined value, the determination is negative (it is determined that the second drag operation 63 depicted in FIG. 28 as an example is not part of the first drag operation 61), and processing moves to step 318. In step 316, if the angle difference calculated in step 314 is less than the second predetermined value, the determination is positive (it is determined that the second drag operation 63 depicted in FIG. 28 as an example is part of the first drag operation 61), and processing moves to step 330.

In step 318, the held notification unit 24 notifies, to the application 18, the DG finish information having coordinates included in the applied operation information (DG start information) being held, and, thereafter, processing moves to step 320. By the processing of step 318 being performed, it is deemed that the first drag operation 61 finished at the start position Ps depicted in FIG. 28 as an example, and the DG finish information relating to the first drag operation 61 is notified to the application 18.

In step 320, the held notification unit 24 notifies the applied operation information (DG start information) being held to the application 18, and, thereafter, processing moves to step 322. By the processing of step 320 being performed, it is determined that the second drag operation 63 started at the start position Ps depicted in FIG. 28 as an example, and the DG start information relating to the second drag operation 63 is notified to the application 18.

In step 322, the held notification unit 24 deletes the applied operation information (DG start information) being held from the holding operation storage region 32D, and, thereafter, processing moves to step 324.

In step 324, the held notification unit 24 stores (overwrites and saves) the coordinates of the DG finish information stored in the applied operation storage region 32C, in the DG coordinates storage region 32G as the DG position coordinates, and, thereafter, processing moves to step 326.

In step 326, the notification of the DG finish information to the application 18 is held, and, thereafter, processing moves to step 328.

In step 328, the held notification unit 24 activates the timer, and, thereafter, the second finishing processing is finished.

In step 330, the held notification unit 24 notifies, to the application 18, the DG movement information having coordinates included in the applied operation information (DG start information) being held, and, thereafter, processing moves to step 322. In this way, by the processing of step 330 being performed, it is deemed that the first drag operation 61 is continuing at the start position Ps depicted in FIG. 28 as an example, and the DG movement information relating to the first drag operation 61 is notified to the application 18.

In the third finishing processing depicted in FIG. 19, first, in step 340, the held notification unit 24 stops the timer, and, thereafter, processing moves to step 342.

In step 342, the held notification unit 24 calculates the DG direction angle (angle θ2 in the example depicted in FIG. 28) from the latest coordinates (the coordinates included in the DG finish information) and the DG position coordinates stored in the DG coordinates storage region 32G, and stores (overwrites and saves) the DG direction angle in the DG angle storage region 32F.

In the following step 344, the held notification unit 24 stores (overwrites and saves) the coordinates of the DG finish information stored in the applied operation storage region 32C, in the DG coordinates storage region 32G as the DG position coordinates, and, thereafter, processing moves to step 346.

In step 346, the held notification unit 24 deletes the applied operation information being held from the holding operation storage region 32D, and, thereafter, processing moves to step 348. It ought to be noted that a possible example of an applied operation indicated by the applied operation information deleted in step 346 is a tap operation that, while a drag operation is being performed by one indicating body from among two indicating bodies (for example, the index finger of the left hand and the index finger of the right hand), has been erroneously performed by the other indicating body.

In step 348, the held notification unit 24 holds the notification of the DG finish information to the application 18, and, thereafter, processing moves to step 350.

In step 350, the held notification unit 24 activates the timer, and, thereafter, the third finishing processing is finished.

In the DG moving processing depicted in FIG. 20, first, in step 360, the held notification unit 24 determines whether or not the reference time Ts has elapsed from the timer being activated. In step 360, if the reference time Ts has elapsed from the timer being activated, the determination is positive, and processing moves to step 364. In step 360, if the reference time Ts has not elapsed from the timer being activated, the determination is negative, and processing moves to step 366.

In step 364, the held notification unit 24 executes the first moving processing depicted in FIG. 21 as an example, and, thereafter, the DG moving processing is finished.

In step 366, the held notification unit 24 determines whether or not the applied operation information being held is DG start information. In step 366, if the applied operation information being held is DG start information (in the example depicted in FIG. 28, if the DG start information relating to the start position Ps is being held), the determination is positive, and processing moves to step 368. In step 366, if the applied operation information being held is not DG start information (for example, if tap operation information is being held due to another indicating body having performed a tap operation during a drag operation (if the mid-DG flag is on)), the determination is negative, and processing moves to step 370.

In step 368, the held notification unit 24 executes the second moving processing depicted in FIG. 22 as an example, and, thereafter, the DG moving processing is finished.

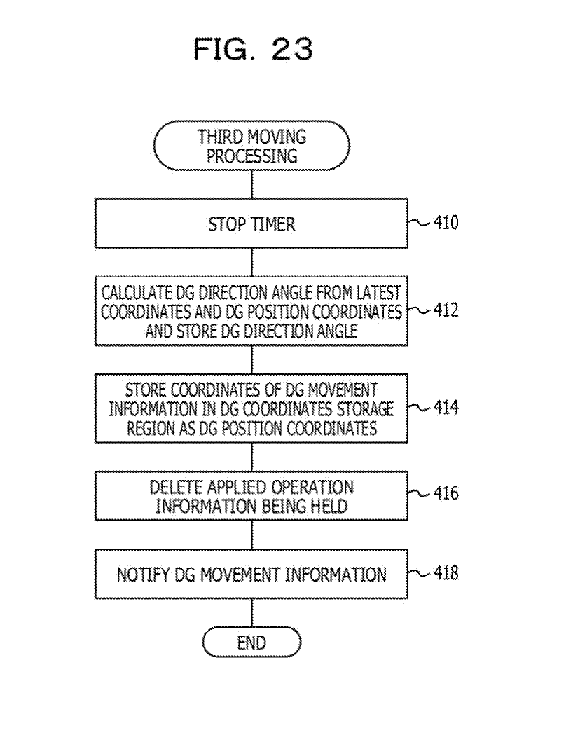

In step 370, the held notification unit 24 executes the third moving processing depicted in FIG. 23 as an example, and, thereafter, the DG moving processing is finished.

In the first moving processing depicted in FIG. 21, first, in step 380, the held notification unit 24 calculates the DG direction angle from the latest coordinates and the DG position coordinates stored in the DG coordinates storage region 32G, and stores (overwrites and saves) the DG direction angle in the DG angle storage region 32F. It ought to be noted that, in step 380, the latest coordinates refer to coordinates included in DG movement information relating to position Ps+1 in the case where position Ps+1 is a midway position in the second drag operation 63 as depicted in FIG. 28 as an example. Furthermore, the DG direction angle calculated in step 380 refers to, for example, angle θ2 depicted in FIG. 28.

In step 382, the held notification unit 24 stores (overwrites and saves) the coordinates of the DG movement information stored in the applied operation storage region 32C, in the DG coordinates storage region 32G as the DG position coordinates, and, thereafter, processing moves to step 384.

In step 384, the held notification unit 24 notifies the DG movement information stored in the applied operation storage region 32C to the application 18, and also deletes the DG movement information from the applied operation storage region 32C, and, thereafter, the first moving processing is finished.

In the second moving processing depicted in FIG. 22, first, in step 390, the held notification unit 24 stops the timer, and, thereafter, processing moves to step 392.

In step 392, the held notification unit 24 calculates the DG direction angle (angle θ2 in the example depicted in FIG. 28) from the latest coordinates and the DG position coordinates stored in the DG coordinates storage region 32G, and stores (overwrites and saves) the DG direction angle in the DG angle storage region 32F, and, thereafter, processing moves to step 394. It ought to be noted that, in step 392, the latest coordinates refer to coordinates included in DG movement information relating to position Ps+1 in the case where position Ps+1 is a midway position in the second drag operation 63 as depicted in FIG. 28 as an example.

In step 394, the held notification unit 24 calculates the angle difference (|θ2−θ3| in the example depicted in FIG. 28) between the DG direction angle stored in the DG angle storage region 32F and the inter-operation angle stored in the inter-operation angle storage region 32E, and, thereafter, processing moves to step 396.

In step 396, the held notification unit 24 determines whether or not the angle difference calculated in step 394 is less than the second predetermined value. In step 396, if the angle difference calculated in step 394 is equal to or greater than the second predetermined value, the determination is negative (it is determined that the second drag operation 63 depicted in FIG. 28 as an example is not part of the first drag operation 61), and processing moves to step 398. In step 396, if the angle difference calculated in step 394 is less than the second predetermined value, the determination is positive (it is determined that the second drag operation 63 depicted in FIG. 28 as an example is part of the first drag operation 61), and processing moves to step 408.

In step 398, the held notification unit 24 notifies, to the application 18, the DG finish information having coordinates included in the applied operation information (DG start information) being held, and, thereafter, processing moves to step 400. By the processing of step 398 being performed, it is deemed that the first drag operation 61 finished at the start position Ps depicted in FIG. 28 as an example, and the DG finish information relating to the first drag operation 61 is notified to the application 18.

In step 400, the held notification unit 24 notifies the applied operation information (DG start information) being held to the application 18, and, thereafter, processing moves to step 402. By the processing of step 400 being performed, it is determined that the second drag operation 63 started at the start position Ps depicted in FIG. 28 as an example, and the DG start information relating to the second drag operation 63 is notified to the application 18.

In step 402, the held notification unit 24 deletes the applied operation information (DG start information) being held from the holding operation storage region 32D, and, thereafter, processing moves to step 404.

In step 404, the held notification unit 24 stores (overwrites and saves) the coordinates of the DG movement information stored in the applied operation storage region 32C, in the DG coordinates storage region 32G as the DG position coordinates, and, thereafter, processing moves to step 406.

In step 406, the held notification unit 24 notifies the DG movement information stored in the applied operation storage region 32C to the application 18, and also deletes the DG movement information from the applied operation storage region 32C, and, thereafter, the second moving processing is finished.

In step 408, the held notification unit 24 notifies, to the application 18, the DG movement information having coordinates included in the applied operation information (DG start information) being held, and, thereafter, processing moves to step 402. In this way, by the processing of step 408 being performed, the application 18 is notified that the drag operation is still continuing.

In the third moving processing depicted in FIG. 23, first, in step 410, the held notification unit 24 stops the timer, and, thereafter, processing moves to step 412.

In step 412, the held notification unit 24 calculates the DG direction angle (angle θ2 in the example depicted in FIG. 28) from the latest coordinates (the coordinates included in the DG movement information) and the DG position coordinates stored in the DG coordinates storage region 32G, and stores (overwrites and saves) the DG direction angle in the DG angle storage region 32F.

In the following step 414, the held notification unit 24 stores (overwrites and saves) the coordinates of the DG movement information stored in the applied operation storage region 32C, in the DG coordinates storage region 32G as the DG position coordinates, and, thereafter, processing moves to step 416.

In step 416, the held notification unit 24 deletes the applied operation information being held from the holding operation storage region 32D, and, thereafter, processing moves to step 418. It ought to be noted that a possible example of an applied operation indicated by the applied operation information deleted in step 416 is a tap operation that, while a drag operation is being performed by one indicating body from among two indicating bodies (for example, the index finger of the left hand and the index finger of the right hand), has been erroneously performed by the other indicating body.

In step 418, the held notification unit 24 notifies the DG movement information stored in the applied operation storage region 32C to the application 18, and also deletes the DG movement information from the applied operation storage region 32C, and, thereafter, the third moving processing is finished.

Next, time-elapsed notification processing performed by the smart device 10 using the CPU 30 executing the time-elapsed notification program 42 if the reference time Ts has elapsed from the timer being activated is described with reference to FIG. 24. It ought to be noted that, hereafter, for convenience of explanation, an explanation is provided for the case where the CPU 30 is executing the application 18 in parallel with execution of the time-elapsed notification program 42.

In the time-elapsed notification processing depicted in FIG. 24, first, in step 420, the time-elapsed notification unit 26 determines whether or not the mid-DG flag is on. In step 420, if the mid-DG flag is on, the determination is positive, and processing moves to step 422. In step 420, if the mid-DG flag is not on (if the mid-DG flag is off), the determination is negative, and processing moves to step 434.

In step 422, the time-elapsed notification unit 26 determines whether or not the applied operation information being held is DG start information. In step 422, if the applied operation information being held is DG start information, the determination is positive, and processing moves to step 424. In step 422, if the applied operation information being held is not DG start information, the determination is negative, and processing moves to step 426.

In step 424, the time-elapsed notification unit 26 continues the held state of the DG start information, and, thereafter, the time-elapsed notification processing is finished.

In step 426, the time-elapsed notification unit 26 determines whether or not the applied operation information being held is DG finish information. In step 426, if the applied operation information being held is DG finish information, the determination is positive, and processing moves to step 428. In step 426, if the applied operation information being held is not DG finish information, the determination is negative, and processing moves to step 434.

In step 428, the time-elapsed notification unit 26 stores (overwrites and saves) the initially set value in the DG angle storage region 32F, and, thereafter, processing moves to step 430.

In step 430, the time-elapsed notification unit 26 notifies the DG finish information stored in the applied operation storage region 32C to the application 18, and also deletes the DG finish information from the holding operation storage region 32D, and, thereafter, processing moves to step 432.

In step 432, the time-elapsed notification unit 26 sets the mid-DG flag to off, and, thereafter, the time-elapsed notification processing is finished.

In step 434, the time-elapsed notification unit 26 notifies the applied operation information being held to the application 18, and also deletes the applied operation information being held from the holding operation storage region 32D, and, thereafter, the time-elapsed notification processing is finished.

As described above, in the smart device 10, a preceding contact operation and a succeeding contact operation performed before and after a non-contact period on the touch panel 12 are detected by the detection unit 14. There is a tendency for either of the elapsed time (timer operation time) from the finish of the detection of the preceding contact operation to the start of the detection of the succeeding contact operation and the inter-operation distance in the case where the finish of the preceding contact operation has been erroneously detected to be shorter compared to the case where the finish of the preceding contact operation is not erroneously detected. Therefore, from the timer operation time and the inter-operation distance, it is possible to predict whether or not the finish of the preceding contact operation has been erroneously detected. Thus, in the smart device 10, whether or not the finish of the preceding contact operation has been erroneously detected is determined based on the timer operation time and the inter-operation distance by the determination unit 16. The smart device 10 is thereby able to specify an erroneous operation performed on the touch panel 12.

Furthermore, in the smart device 10, in the case where the timer operation time and the inter-operation distance have satisfied predetermined conditions, it is determined by the determination unit 16 that the preceding contact operation and the succeeding contact operation are one continuous operation. Therefore, even in the case where the user has unintentionally caused a non-detection period to be generated by the touch panel 12, it is possible for the smart device 10 to process the two operations on either side of that non-detection period as one continuous operation.

Furthermore, in the smart device 10, an inter-operation angle is calculated by the determination unit 16 (for example, step 136 (FIG. 8) and step 216 (FIG. 12)). Furthermore, a DG direction angle is calculated by the determination unit 16 (for example, step 170 (FIG. 9), step 312 (FIG. 18), step 380 (FIG. 21), step 392 (FIG. 22), and step 412 (FIG. 23)). Furthermore, a first angle (angle difference) is calculated by the determination unit 16 from the inter-operation angle and the DG direction angle (for example, step 138 (FIG. 8) and step 218 (FIG. 12)). There is a tendency for the first angle calculated by the determination unit 16 in the case where the finish of the drag operation (preceding drag operation) that is the preceding contact operation has been erroneously detected to be smaller compared the first angle calculated by the determination unit 16 in the case where the finish of the preceding drag operation has not been erroneously detected. Thus, in the smart device 10, whether or not the finish of the preceding drag operation has been erroneously detected is determined based on the first angle, the timer operation time, and the inter-operation distance by the determination unit 16. The smart device 10 is thereby able to specify an erroneous operation generated by a preceding drag operation.

Furthermore, in the smart device 10, in the case where the first angle, the timer operation time, and the inter-operation distance have satisfied predetermined conditions, it is determined by the determination unit 16 that the preceding drag operation and the succeeding contact operation are one continuous operation (drag operation). Therefore, even in the case where the user has unintentionally caused a non-detection period to be generated by the touch panel 12, it is possible for the smart device 10 to process the preceding drag operation and the succeeding contact operation on either side of that non-detection period as one continuous drag operation.

As described above, an example has been described in which, in the case where the first angle, the timer operation time, and the inter-operation distance have satisfied predetermined conditions, the determination unit 16 determines that the preceding drag operation and the succeeding contact operation are one continuous operation (drag operation); however, the disclosed technology is not restricted to this. For example, in the case where the timer operation time and the inter-operation distance have satisfied predetermined conditions, it may be determined that the preceding drag operation and the succeeding contact operation are one continuous operation. Furthermore, in the case where the timer operation time and the inter-operation distance have satisfied predetermined conditions, it may be determined that the preceding tap operation and the succeeding drag operation are one continuous operation (drag operation). Furthermore, in the case where the timer operation time and the inter-operation distance have satisfied predetermined conditions, it may be determined that the preceding tap operation and the succeeding tap operation are one continuous operation (for example, a tap operation or a drag operation). In this way, in the case where the timer operation time and the inter-operation distance have satisfied predetermined conditions, it may be determined that the preceding contact operation and the succeeding contact operation are one continuous operation (for example, one operation from among the preceding and succeeding contact operations). In this case, because the smart device 10 does not have to calculate the first angle, an increase in processing speed may be expected.

Furthermore, in the smart device 10, if the first angle is less than the second predetermined value, the timer operation time is less than the reference time Ts, and the inter-operation distance is less than the first predetermined value, there is a possibility that the finish of the preceding drag operation has been erroneously detected. Thus, in the smart device 10, if the first angle is less than the second predetermined value, the timer operation time is less than the reference time Ts, and the inter-operation distance is less than the first predetermined value, it is determined by the determination unit 16 that the finish of the preceding drag operation has been erroneously detected. Here, the case where the first angle is less than the second predetermined value, the timer operation time is less than the reference time Ts, and the inter-operation distance is less than the first predetermined value refers to, for example, the case where the determination of step 142 depicted in FIG. 8 is positive and the case where the determination of step 220 depicted in FIG. 12 is positive. In this way, it is possible for the smart device 10 to realize, with a simple configuration, the specifying of an erroneous operation generated by a preceding drag operation.

Furthermore, in the smart device 10, if a tap operation (succeeding tap operation) that is a succeeding contact operation has been detected, and the first angle, the timer operation time, and the inter-operation distance have satisfied the first predetermined condition, it is deemed that there is a possibility that the preceding drag operation is still being continued. Thus, in the smart device 10, if the succeeding tap operation is detected, and the first angle, the timer operation time, and the inter-operation distance have satisfied the first predetermined condition, it is determined by the determination unit 16 that the succeeding tap operation is part of the preceding drag operation (step 168). Here, the first predetermined condition refers to the condition that the first angle is less than the second predetermined value, the timer operation time is less than the reference time Ts, and the inter-operation distance is less than the first predetermined value. Therefore, the smart device 10 is able to determine that a succeeding tap operation is part of a preceding drag operation even when an erroneous operation has been generated by the preceding drag operation.

Furthermore, in the smart device 10, the second angle (angle difference) is calculated by the determination unit 16 from the DG direction angle of a drag operation (succeeding drag operation) that is a succeeding drag operation and from the inter-operation angle (for example, step 314 (FIG. 18)). There is a tendency for the second angle in the case where a non-detection period between the preceding drag operation and the succeeding drag operation has been generated contrary to the intention of the user to be smaller compared to the case where a non-detection period is intentionally generated by the user. If this tendency is used, it is possible to use the second angle (|θ2−θ3| in the example depicted in FIG. 28) calculated by the determination unit 16 to predict whether or not a non-detection period between a preceding drag operation and a succeeding drag operation has been generated contrary to the intention of the user. Thus, if the succeeding drag operation is detected, and the first angle, the second angle, the timer operation time, and the inter-operation distance have satisfied the second predetermined condition, it is determined by the determination unit 16 that the succeeding drag operation is part of the preceding drag operation (for example, step 330 (FIG. 18)). Here, the second predetermined condition refers to the condition that first angle and the second angle are less than the second predetermined value, the timer operation time is less than the reference time Ts, and the inter-operation distance is less than the first predetermined value. Therefore, the smart device 10 is able to determine that a succeeding drag operation is part of a preceding drag operation even when an erroneous operation has been generated by the preceding drag operation.

Furthermore, in the smart device 10, if the detected preceding contact operation is a tap operation (preceding tap operation), the timer operation time is less than the reference time Ts, and the inter-operation distance is less than the first predetermined value, there is a possibility that the finish of the preceding tap operation has been erroneously detected. Thus, in the smart device 10, if a preceding tap operation is detected, the timer operation time is less than the reference time Ts, and the inter-operation distance is less than the first predetermined value, it is determined by the determination unit 16 that the finish of the preceding tap operation has been erroneously detected. Here, the case where the preceding contact operation is a preceding tap operation, the timer operation time is less than the reference time Ts, and the inter-operation distance is less than the first predetermined value refers to, for example, the case where the determination is negative in step 164 of FIG. 9 and the case where the determination is positive in step 192 of FIG. 10. In this way, it is possible for the smart device 10 to realize, with a simple configuration, the specifying of an erroneous operation generated by a preceding tap operation.

Furthermore, in the smart device 10, a basic operation is detected by the basic operation detection unit 20, and based on the basic operation detected by the basic operation detection unit 20, an applied operation is detected by the applied operation detection unit 22. This applied operation is defined by operation units in which the finish of a preceding contact operation is able to be detected. Therefore, the smart device 10 is able to easily detect the finish of a preceding contact operation.

Furthermore, in the smart device 10, basic operation information is notified to the application 18 by the basic operation detection unit 20 (for example, step 106 (FIG. 5)). Furthermore, applied operation information that indicates an applied operation selected based on a determination result, from applied operation information generated by the applied operation detection unit 22 is notified to the application 18 by the determination unit 16 (for example, step 198 (FIG. 10) and step 434 (FIG. 24)). The smart device 10 is thereby able to increase operability with respect to the application 18.

Furthermore, in the smart device 10, using the held notification unit 24, a notification of DG finish information to the application 18 is held, and it is determined whether or not the drag finish operation indicated by the DG finish information being held is an erroneous operation (for example, step 214 (FIG. 12)). If the drag finish operation indicated by the DG finish information being held is not an erroneous operation, the DG finish information is notified to the application 18 by the held notification unit 24 (for example, step 250 (FIG. 14)). Furthermore, if the DG finish information being held by the held notification unit 24 exceeds a predetermined time, the DG finish information being held is notified to the application 18 by the time-elapsed notification unit 26 (for example, step 430 (FIG. 24)). The smart device 10 is thereby able to suppress a decrease in the operability of the application 18 caused by the drag finish operation being an erroneous operation.

It ought to be noted that, in the first embodiment, a common value is used as the first predetermined value in each of step 134, step 192, step 214, and step 262; however, the disclosed technology is not restricted to this. For example, instead of the first predetermined value, values that are individually set in each of step 134, step 192, step 214, and step 262 (for example, values that are different in each of step 134, step 192, step 214, and step 262) may be used.

Furthermore, in the first embodiment, a common value is used as the second predetermined value in each of step 140, step 220, step 316, and step 396; however, the disclosed technology is not restricted to this. For example, instead of the second predetermined value, values that are individually set in each of step 140, step 220, step 316, and step 396 (for example, values that are different in each of step 140, step 220, step 316, and step 396) may be used.

Furthermore, in the first embodiment, the reference time Ts is a fixed time that is set by default; however, the disclosed technology is not restricted to this, and the reference time Ts may be a time instructed by the user via the touch panel display 48.

Furthermore, in the first embodiment, in step 318 of FIG. 18, it is deemed that the first drag operation 61 finished at the start position Ps depicted in FIG. 28, and the DG finish information having the coordinates of the start position Ps is notified to the application 18; however, the disclosed technology is not restricted to this. For example, it is permissible for it to be deemed that the first drag operation 61 has finished at the finish position Pm depicted in FIG. 28 as an example, and the DG finish information having the coordinates of the finish position Pm to be notified to the application 18.

Furthermore, in the first embodiment, in step 398 of FIG. 22, it is deemed that the first drag operation 61 finished at the start position Ps depicted in FIG. 28, and the DG finish information having the coordinates of the start position Ps is notified to the application 18; however, the disclosed technology is not restricted to this. For example, it is permissible for it to be deemed that the first drag operation 61 has finished at the finish position Pm depicted in FIG. 28 as an example, and the DG finish information having the coordinates of the finish position Pm to be notified to the application 18.

Furthermore, in the first embodiment, in step 240 of FIG. 13, the DG movement information having the coordinates of the applied operation information being held is notified to the application 18; however, the disclosed technology is not restricted to this. For example, the DG movement information having the latest coordinates instead of the coordinates of the applied operation information being held may be notified to the application 18.

Furthermore, in the first embodiment, tap operation information, DG start information, DG movement information, and DG finish information are given as examples of applied operation information; however, the disclosed technology is not restricted to this, and applied operation information may indicate other single operations and multiple operations. However, because there are two contact indication positions in a pinch-open start operation, a pinch-open finish operation, a pinch-close start operation, and a pinch-close finish operation, processing that is the same as the drag operation described in the first embodiment is performed for the slide operation for each contact indication position.

Furthermore, in the first embodiment, an example has been described in which the held notification unit 24 calculates an angle difference in step 138 depicted in FIG. 8 and in step 218 depicted in FIG. 12, and the calculated angle difference is compared with the second predetermined value; however, the angle difference does not have to be calculated and compared with the second predetermined value. In this case, because the processing for calculating and comparing the angle difference with the second predetermined value is omitted, the time desired for the overall processing is shortened. However, in order to increase determination precision, it is preferable for the processing for calculating and comparing the angle difference with the second predetermined value to be performed.

Furthermore, in the first embodiment, a flick operation is treated as a single operation; however, the disclosed technology is not restricted to this, and a flick operation may be treated as a multiple operation. In this case, a flick operation, for example, is defined by three operation units (applied operations) in the same manner as a drag operation. In other words, a flick operation is defined by the three applied operations of a flick start operation, a flick movement operation, and a flick finish operation.

Furthermore, in the first embodiment, an example has been described in which basic operation information is notified to the application 18; however, the disclosed technology is not restricted to this, and it is permissible for basic operation information to not be notified to the application 18.

Furthermore, in the first embodiment, an example has been described in which applied operation information indicating an applied operation determined as not being an erroneous operation is notified to the application 18; however, the disclosed technology is not restricted to this. For example, it is permissible for the result of having determined whether or not an erroneous operation is present to be output to a predetermined output destination (for example, an external device connected to the smart device 10).

Furthermore, in the first embodiment, an example has been described in which it is determined that a drag operation is still continuing if an erroneous operation generated by the drag operation on the touch panel 12 is specified; however, the disclosed technology is not restricted to this. For example, it is permissible for the CPU 30 to control the display 50 in such a way that a specific mark is displayed at the position where an erroneous operation has been generated on the touch panel 12. The user is thereby able to easily recognize a position at which there is a possibility that an erroneous operation has been performed on the touch panel 12.

### Second Embodiment

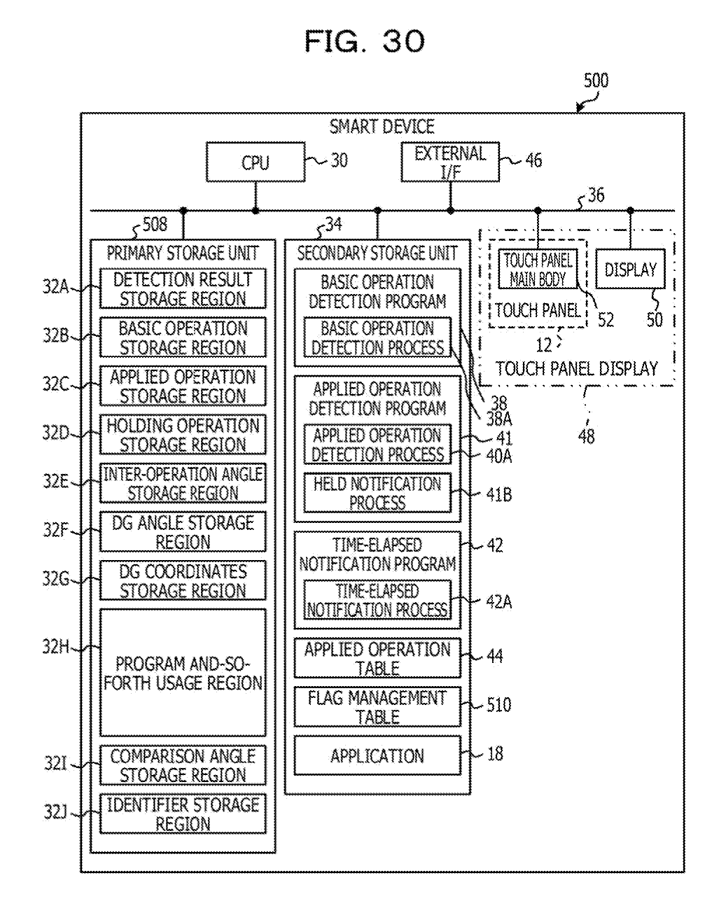

In the first embodiment, a smart device 10 in which a plurality of multiple operations are not detected in parallel has been described as an example; however, in the second embodiment, a smart device 500 in which a plurality of multiple operations are detected in parallel is described as an example (see FIG. 1 and FIG. 30). Furthermore, in the second embodiment, descriptions of constituent elements that have been described in embodiment 1 and are appended with the same symbols have been omitted, and the differences with the first embodiment are described.

As depicted in FIG. 1 as an example, compared to the smart device 10 described in the first embodiment, the smart device 500 according to the second embodiment is different in having a detection unit 502 instead of the detection unit 14, and in having a determination unit 504 instead of the determination unit 16.

The detection unit 502 is a detection unit that is able to detect a plurality of multiple operations (for example, a drag operation (an example of a plurality of slide operations in the disclosed technology), a long-press operation, a pinch-open operation, and a pinch-close operation) in parallel as preceding contact operations.

Compared to the determination unit 16, the determination unit 504 is different in having a held notification unit 506 instead of the held notification unit 24. If a plurality of drag operations are detected in parallel as preceding contact operations, with regard to each of the plurality of detected drag operations, the held notification unit 506 determines, based on an angle difference, a reference time Ts, and an inter-operation distance, whether or not a finish operation included in the drag operations is an erroneous operation.

As depicted in FIG. 30 as an example, compared to the smart device 10 depicted in FIG. 2, the smart device 500 is different in having a primary storage unit 508 instead of the primary storage unit 32. Compared to the primary storage unit 32 depicted in FIG. 2, the primary storage unit 508 is different in having a detection result storage region 32A, a basic operation storage region 32B, an applied operation storage region 32C, and a holding operation storage region 32D for each identifier stored in a flag management table 510 described hereafter. Furthermore, compared to the primary storage unit 32 depicted in FIG. 2, the primary storage unit 508 is different in having an inter-operation angle storage region 32E, a DG angle storage region 32F, a DG coordinates storage region 32G, and a program and-so-forth usage region 32H for each identifier stored in the flag management table 510 described hereafter. In addition, compared to the primary storage unit 32 depicted in FIG. 2, the primary storage unit 508 is different in having a comparison angle storage region 32I and an identifier storage region 323 for each identifier stored in the flag management table 510 described hereafter.

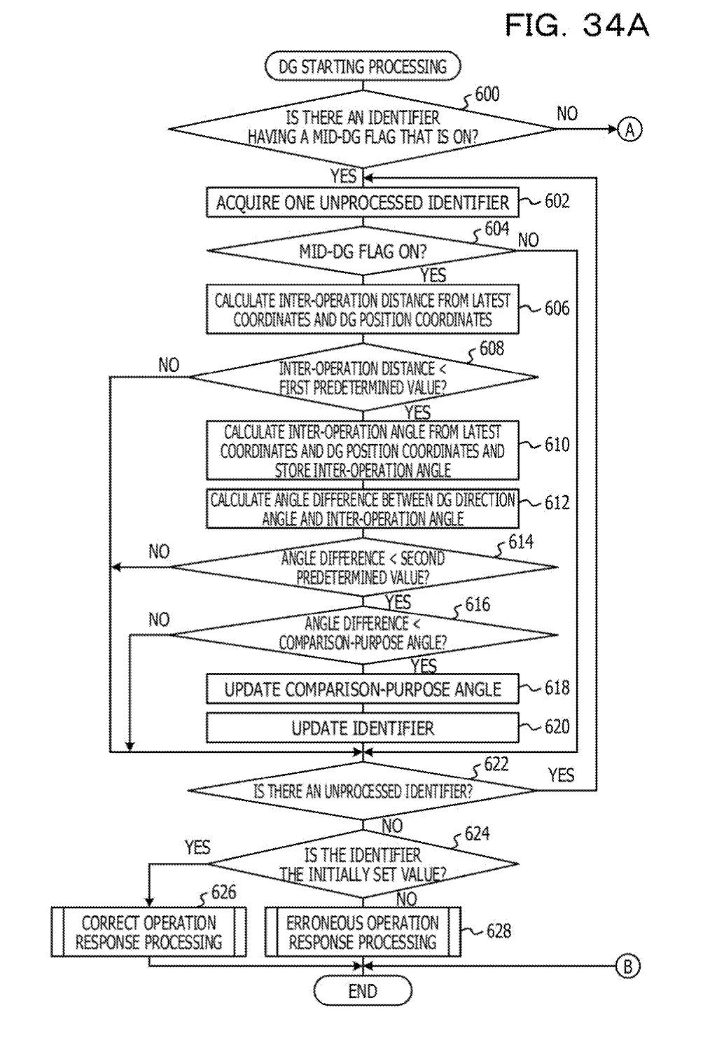

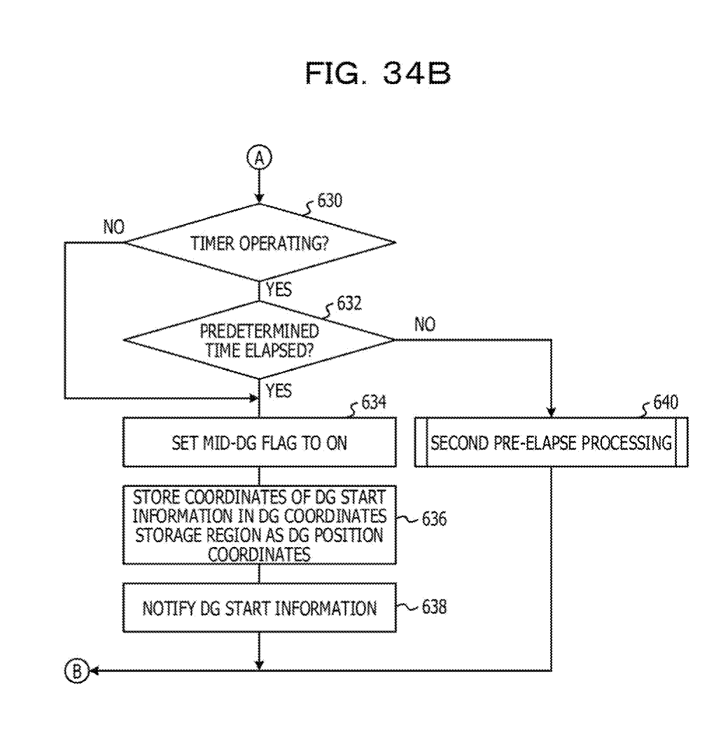

The comparison angle storage region 32I is a storage region for storing a comparison-purpose angle used in step 616 (see FIG. 34) described hereafter, and stores 10,000 degrees (an angle the actual calculation of which is not possible) for example as an initially set value. The identifier storage region 32J is a storage region for storing an identifier stored in the flag management table 510 described hereafter, and stores “10,000” (an identifier that is not stored in the flag management table 510) for example as an initially set value.

Compared to the smart device 10 depicted in FIG. 2, the smart device 500 is different in that an applied operation detection program 41 is stored in the secondary storage unit 34 instead of the applied operation detection program 40, and in that the flag management table 510 is stored in the secondary storage unit 34.

The CPU 30 reads the applied operation detection program 41 from the secondary storage unit 34 and deploys this in the program and-so-forth usage region 32H, and executes processes of the applied operation detection program 41. Compared with the applied operation detection program 40 depicted in FIG. 2, the applied operation detection program 41 is different in having a held notification process 41B instead of the held notification process 40B. The CPU 30 executes the held notification process 41B, and thereby operates as the held notification unit 506 depicted in FIG. 1.

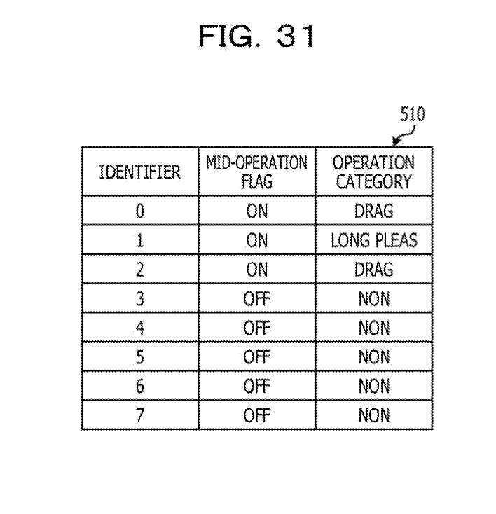

The flag management table 510 is a table that manages multiple operations that are detected in parallel. As depicted in FIG. 31 as an example, the flag management table 510 stores a plurality of identifiers, mid-operation flags, and operation category information that indicates the categories of multiple operations (categories of mid-operation flags) currently being performed on the touch panel 12. Possible examples of mid-operation flags are the mid-DG flag described in the first embodiment, a mid-LP flag indicating that a long-press operation is being carried out, a mid-PO flag indicating that a pinch-open operation is being carried out, and a mid-PC flag indicating that a pinch-close operation is being carried out.

Based on detection result information input from the touch panel 12, the CPU 30 updates, for each identifier, the mid-operation flags and the operation category information stored in the flag management table 510. In the example depicted in FIG. 31, mid-operation flags and operation category information are associated with each of a plurality of identifiers that are integers from “0” to “7”. Therefore, by referring to the flag management table 510, the CPU 30 is able to determine whether or not multiple operations are being performed in parallel on the touch panel 12 in a maximum of eight locations.

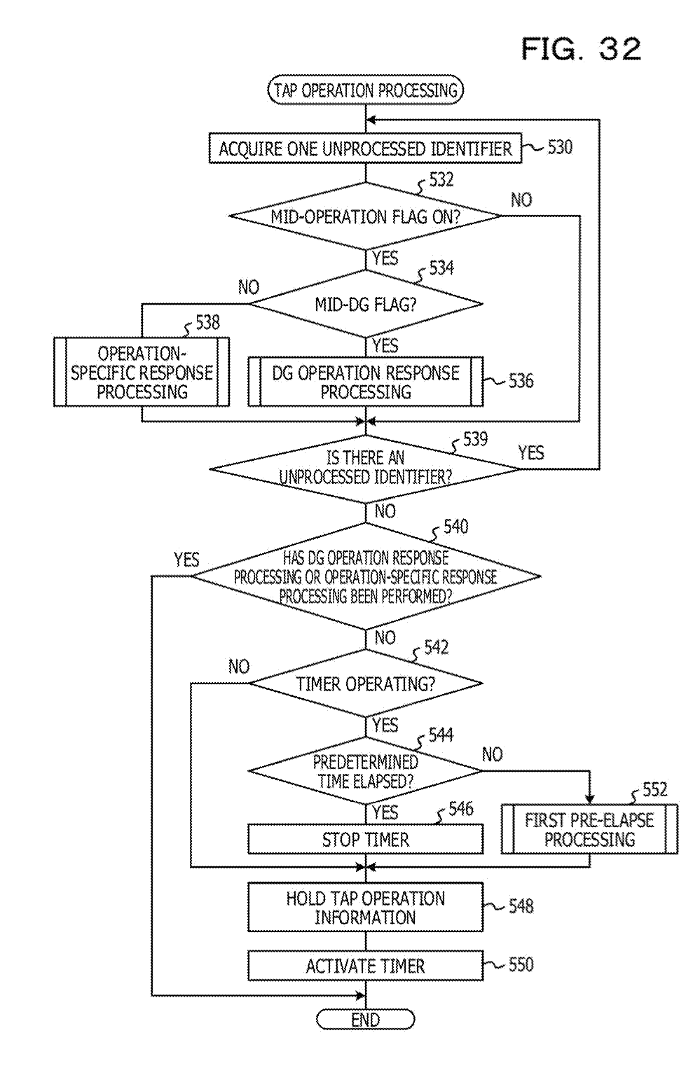

The operation of the second embodiment is described next. Compared to the smart device 10 according to the first embodiment, in the smart device 500, there is a difference in that the tap operation processing depicted in FIG. 32 is performed instead of the tap operation processing depicted in FIG. 8. Furthermore, compared to the smart device 10 according to the first embodiment, in the smart device 500, there is a difference in that the DG starting processing depicted in FIG. 34 is performed instead of the DG starting processing depicted in FIG. 12. Therefore, hereafter, the differences with the first embodiment are described.

In the tap operation processing depicted in FIG. 32, first, in step 530, the held notification unit 506 acquires one unprocessed identifier from the flag management table 510, and, thereafter, processing moves to step 532. Here, an unprocessed identifier means an identifier for which the processing of step 532 and thereafter, which is described hereafter, has not yet been performed.

In step 532, the held notification unit 506 determines whether or not the mid-operation flag associated with the identifier acquired in step 530 from among the mid-operation flags stored in the flag management table 510 is on. In step 532, if the mid-operation flag associated with the identifier acquired in step 530 from among the mid-operation flags stored in the flag management table 510 is on, the determination is positive, and processing moves to step 534. In step 532, if the mid-operation flag associated with the identifier acquired in step 530 from among the mid-operation flags stored in the flag management table 510 is off, the determination is negative, and processing moves to step 539.

In step 534, the held notification unit 506 determines whether or not the mid-operation flag determined in step 532 is a mid-DG flag. In step 534, if the mid-operation flag determined in step 532 is a mid-DG flag, the determination is positive, and processing moves to step 536. In step 534, if the mid-operation flag determined in step 532 is not a mid-DG flag, the determination is negative, and processing moves to step 538.

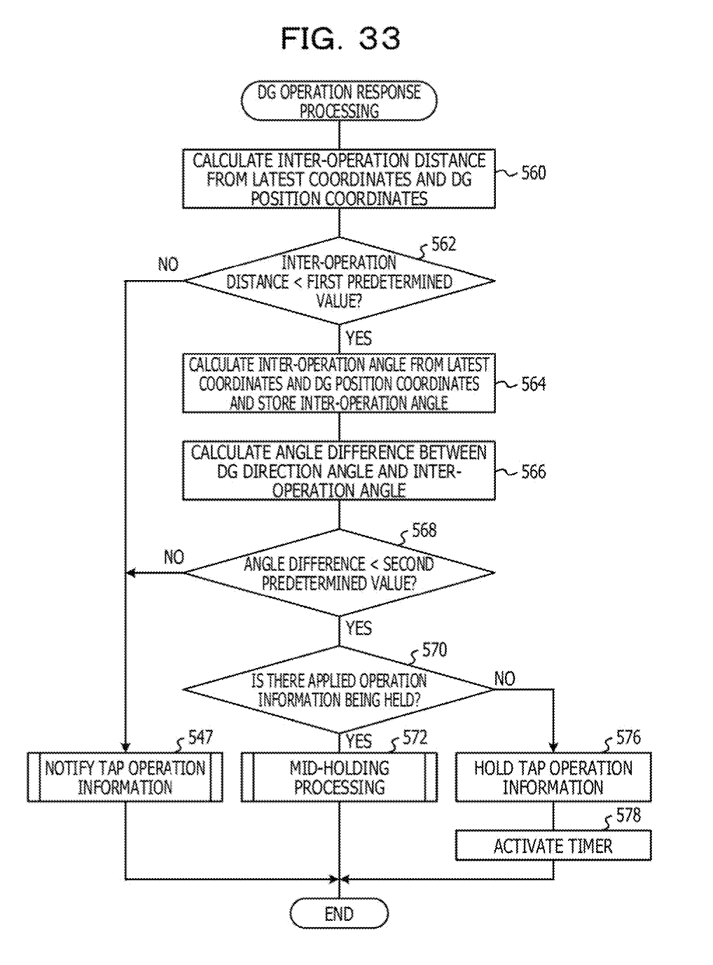

In step 536, the held notification unit 506 executes drag operation response processing (DG operation response processing) depicted in FIG. 33 as an example, and, thereafter, processing moves to step 539.

In step 538, the held notification unit 506 executes operation-specific response processing, and, thereafter, processing moves to step 539. Here, if the mid-operation flag determined in step 532 is a mid-LP flag, the operation-specific response processing refers to processing that is the same as the DG operation response processing depicted in FIG. 33 as an example (processing differing only in that the drag operation is replaced with a long-press operation). Furthermore, if the mid-operation flag determined in step 532 is a mid-PO flag, the operation-specific response processing refers to processing that is the same as the DG operation response processing depicted in FIG. 33 as an example (processing differing only in that the drag operation is replaced with a pinch-open operation). Furthermore, if the mid-operation flag determined in step 532 is a mid-PC flag, the operation-specific response processing refers to processing that is the same as the DG operation response processing depicted in FIG. 33 as an example (processing differing only in that the drag operation is replaced with a pinch-close operation).

In step 539, the held notification unit 506 determines whether or not an unprocessed identifier (an identifier that has not yet been acquired in step 530) is present. In step 539, if an unprocessed identifier is present, the determination is positive, and processing moves to step 530. In step 539, if an unprocessed identifier is not present, the determination is negative, and processing moves to step 540.

In step 540, the held notification unit 506 determines whether or not DG operation response processing or operation-specific response processing has been performed. In step 540, if DG operation response processing or operation-specific response processing has been performed, the determination is positive, and the tap operation processing is finished. In step 540, if neither DG operation response processing nor operation-specific response processing has been performed, the determination is negative, and processing moves to step 542.

In step 542, the held notification unit 506 determines whether or not the timer is operating. In step 542, if the timer is operating, the determination is positive, and processing moves to step 544. In step 542, if the timer is not operating, the determination is negative, and processing moves to step 548.

In step 544, the held notification unit 506 determines whether or not the reference time Ts has elapsed from the timer being activated. In step 544, if the reference time Ts has elapsed from the timer being activated, the determination is positive, and processing moves to step 546. In step 544, if the reference time Ts has not elapsed from the timer being activated, the determination is negative, and processing moves to step 552.

In step 546, the held notification unit 506 stops the timer, and, thereafter, processing moves to step 548.

In step 548, the held notification unit 506 holds the notification of the tap operation information to the application 18, and, thereafter, processing moves to step 550.

In step 550, the held notification unit 506 activates the timer, and, thereafter, the tap operation processing is finished.

In step 552, the held notification unit 506 executes the first pre-elapse processing depicted in FIG. 10 as an example, and, thereafter, processing moves to step 548.

In the DG operation response processing depicted in FIG. 33, first, in step 560, the held notification unit 506 calculates the inter-operation distance from the latest coordinates and the DG position coordinates stored in the DG coordinates storage region 32G, and, thereafter, processing moves to step 562.

In step 562, the held notification unit 506 determines whether or not the inter-operation distance calculated in step 560 is less than the first predetermined value. In step 562, if the inter-operation distance calculated in step 560 is less than the first predetermined value, the determination is positive, and processing moves to step 564. In step 562, if the inter-operation distance calculated in step 560 is equal to or greater than the first predetermined value, the determination is negative, and processing moves to step 574.

In step 564, the held notification unit 506 calculates the inter-operation angle from the latest coordinates and DG position coordinates stored in the DG coordinates storage region 32G, and stores (overwrites and saves) the calculated inter-operation angle in the inter-operation angle storage region 32E, and, thereafter, processing moves to step 566.

In step 566, the held notification unit 506 calculates the angle difference between a DG direction angle stored in the DG angle storage region 32F and the inter-operation angle stored in the inter-operation angle storage region 32E, and, thereafter, processing moves to step 568.

In step 568, the held notification unit 506 determines whether or not the angle difference calculated in step 566 is less than the second predetermined value. In step 568, if the angle difference calculated in step 566 is less than the second predetermined value, the determination is positive, and processing moves to step 570. In step 568, if the angle difference calculated in step 566 is equal to or greater than the second predetermined value, the determination is negative, and processing moves to step 574.

In step 570, the held notification unit 506 determines whether or not there is applied operation information being held. In step 570, if there is applied operation information being held, the determination is positive, and processing moves to step 572. In step 570, if there is no applied operation information being held, the determination is negative, and processing moves to step 576.

In step 572, the held notification unit 506 executes the mid-holding processing depicted in FIG. 9 as an example, and, thereafter, the tap operation processing is finished.

In step 574, the held notification unit 506 notifies the tap operation information stored in the applied operation storage region 32C to the application 18, and also deletes the tap operation information from the applied operation storage region 32C, and, thereafter, the tap operation processing is finished.

In step 576, the held notification unit 506 holds the notification of the tap operation information to the application 18, and, thereafter, processing moves to step 578.

In step 578, the held notification unit 506 activates the timer, and, thereafter, the tap operation processing is finished.

In the DG starting processing depicted in FIG. 34, first, in step 600, the held notification unit 506 determines whether or not an identifier having a mid-DG flag that is on is present in the flag management table 510. In step 600, if an identifier having a mid-DG flag that is on is present in the flag management table 510, the determination is positive, and processing moves to step 602. In step 600, if an identifier having a mid-DG flag that is on is not present in the flag management table 510, the determination is negative, and processing moves to step 630.

In step 602, the held notification unit 506 acquires one unprocessed identifier from the flag management table 510, and, thereafter, processing moves to step 604. Here, an unprocessed identifier means an identifier for which the processing of step 604 and thereafter, which is described hereafter, has not yet been performed.

In step 604, the held notification unit 506 determines whether or not the mid-operation flag associated with the identifier acquired in step 602 is a mid-DG flag, and whether the mid-DG flag is on. It ought to be noted that it is possible to determine whether or not the mid-operation flag associated with the identifier is a mid-DG flag by referring to the operation category information associated with the identifier.

In step 604, if the mid-operation flag associated with the identifier acquired in step 602 is a mid-DG flag, and the mid-DG flag is on, the determination is positive, and processing moves to step 606. In step 604, if the mid-operation flag associated with the identifier acquired in step 602 is not a mid-DG flag, and the mid-DG flag is off, the determination is negative, and processing moves to step 622.

In step 606, the held notification unit 506 calculates the inter-operation distance from the latest coordinates and the DG position coordinates stored in the DG coordinates storage region 32G, and, thereafter, processing moves to step 608.

In step 608, if the inter-operation distance calculated in step 606 by the held notification unit 506 is less than the first predetermined value, the determination is positive, and processing moves to step 610. In step 608, if the inter-operation distance calculated in step 606 is equal to or greater than the first predetermined value, the determination is negative, and processing moves to step 622.

In step 610, the held notification unit 506 calculates an inter-operation angle from the latest coordinates and DG position coordinates stored in the DG coordinates storage region 32G, and stores (overwrites and saves) the calculated inter-operation angle in the inter-operation angle storage region 32E, and, thereafter, processing moves to step 612.

In step 612, the held notification unit 506 calculates the angle difference between a DG direction angle stored in the DG angle storage region 32F and the inter-operation angle stored in the inter-operation angle storage region 32E, and, thereafter, processing moves to step 614.

In step 614, the held notification unit 506 determines whether or not the angle difference calculated in step 612 is less than the second predetermined value. In step 614, if the angle difference calculated in step 612 is less than the second predetermined value, the determination is positive (it is determined that the applied operation indicated by the applied operation information being held is an erroneous operation), and processing moves to step 616. In step 614, if the angle difference calculated in step 612 is equal to or greater than the second predetermined value, the determination is negative (it is determined that the applied operation indicated by the applied operation information being held is not an erroneous operation), and processing moves to step 622.

In step 616, the held notification unit 506 determines whether or not the angle difference calculated in step 612 is less than a comparison-purpose angle stored in the comparison angle storage region 32I. In step 616, if the angle difference calculated in step 612 is less than the comparison-purpose angle stored in the comparison angle storage region 32I, the determination is positive, and processing moves to step 618. In step 616, if the angle difference calculated in step 612 is equal to or greater than the comparison-purpose angle stored in the comparison angle storage region 32I, the determination is negative, and processing moves to step 622.

In step 618, the held notification unit 506 updates the comparison-purpose angle by storing (overwriting and saving) the angle difference calculated in step 612 in the comparison angle storage region 32I as the comparison-purpose angle, and, thereafter, processing moves to step 620.

In step 620, the held notification unit 506 updates the identifiers stored in the identifier storage region 32J by storing (overwriting and saving) the identifier acquired in step 602 in the identifier storage region 32J, and, thereafter, processing moves to step 622.

In step 622, the held notification unit 506 determines whether or not an unprocessed identifier (for example, an identifier that has not yet been acquired in step 602) is present. In step 622, if an unprocessed identifier is present, the determination is positive, and processing moves to step 602. In step 622, if an unprocessed identifier is not present, the determination is negative, and processing moves to step 624.

In step 624, the held notification unit 506 determines whether or not the identifier stored in the identifier storage region 323 is the initially set value. In step 624, if the identifier stored in the identifier storage region 323 is the initially set value, the determination is positive, and processing moves to step 626. In step 624, if the identifier stored in the identifier storage region 323 is not the initially set value (in the case of any of the identifiers stored in the flag management table 510), the determination is negative, and processing moves to step 628.

In step 626, the held notification unit 506 executes the correct operation response processing depicted in FIG. 14 as an example, and, thereafter, the DG starting processing is finished.

In step 628, the held notification unit 506 executes the erroneous operation response processing depicted in FIG. 13 as an example, and, thereafter, the DG starting processing is finished.

In step 630, the held notification unit 506 determines whether or not the timer is operating. In step 630, if the timer is operating, the determination is positive, and processing moves to step 632. In step 630, if the timer is not operating, the determination is negative, and processing moves to step 634.

In step 632, the held notification unit 506 determines whether or not the reference time Ts has elapsed from the timer being activated. In step 632, if the reference time Ts has elapsed from the timer being activated, the determination is positive, and processing moves to step 634. In step 632, if the reference time Ts has not elapsed from the timer being activated, the determination is negative, and processing moves to step 640.

In step 634, the held notification unit 506 sets the mid-DG flag to on, and, thereafter, processing moves to step 636.

In step 636, the held notification unit 506 stores (overwrites and saves) the coordinates of the DG start information stored in the applied operation storage region 32C, in the DG coordinates storage region 32G as the DG position coordinates, and, thereafter, processing moves to step 638.

In step 638, the held notification unit 506 notifies the DG start information stored in the applied operation storage region 32C to the application 18, and also deletes the DG start information from the applied operation storage region 32C, and, thereafter, the DG starting processing is finished.

In step 640, the held notification unit 506 executes the second pre-elapse processing depicted in FIG. 15 as an example, and, thereafter, the DG starting processing is finished.

As described above, in the smart device 500, a plurality of drag operations (preceding drag operations) are detected in parallel as preceding contact operations by the detection unit 502. Furthermore, if a plurality of preceding drag operations are detected in parallel, with regard to each of the plurality of detected drag operations, whether or not the finish of the preceding drag operation has been erroneously detected is determined based on the angle difference, the reference time Ts, and the inter-operation distance by the determination unit 504. In the smart device 500, is therefore possible to specify, with a high degree of precision, an erroneous operation generated by a preceding drag operation, even if a plurality of preceding drag operations have been detected in parallel.

All documents, patent applications, and technical specifications cited herein are incorporated by reference herein to the same extent as if each document, patent application, and technical specification has been specifically and individually indicated to be incorporated by reference.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A terminal device comprising:
a memory; and
a processor coupled to the memory, configured to
acquire position information indicating a contact position of an indicator with respect to a touch panel,
detect, based on the acquired position information, a preceding contact operation and a succeeding contact operation performed before and after a non-contact period with respect to the touch panel, and
determine that the preceding contact operation and the succeeding contact operation are one continuous operation when an elapsed time and a positional interval satisfy a given condition, the elapsed time being from finish of the preceding contact operation being detected until start of the succeeding contact operation being detected, and the positional interval being between a finish position at which the finish of the preceding contact operation has been detected and a start position at which the start of the succeeding contact operation has been detected.

2. The terminal device according to claim 1,
wherein the processor is configured to
determine that the preceding contact operation and the succeeding contact operation are one continuous operation when a preceding slide operation has been detected as the preceding contact operation, and when a first angle, the elapsed time, and the positional interval satisfy a given condition, the first angle being formed between a finishing slide direction in the preceding slide operation and an inter-operation direction from the finish position toward the start position.

3. The terminal device according to claim 2,
wherein the processor is configured to detect a plurality of slide operations in parallel,
wherein the processor is configured to, when a plurality of slide operations have been detected in parallel as the preceding contact operation, treat each of the plurality of detected slide operations as the preceding slide operation.

4. The terminal device according to claim 1,
wherein the processor is configured to
detect, based on the position information, a basic operation, and
detect, based on the detected basic operation, applied operations that define each of the preceding contact operation and the succeeding contact operation in which the finish of the preceding contact operation is able to be detected.

5. The terminal device according to claim 4,
wherein the processor is configured to
generate basic operation information that indicates the detected basic operation,
notify the generated basic operation information to an application program,
generate applied operation information that indicates the detected applied operation, and
notify, to the application program, applied operation information selected based on a determination result, from the generated applied operation information.

6. The terminal device according to claim 5,
wherein the processor is configured to
hold the notification of the generated applied operation information to the application program,
notify, to the application program, the applied operation information selected based on the determination result, from the applied operation information being held, and
notify the applied operation information being held to the application program when a holding time of the applied operation information being held has elapsed a given time.

7. A machine readable medium storing a program that, when executed by a processor, causes the processor to perform operations comprising:
acquiring position information indicating a contact position of an indicator with respect to a touch panel;
detecting, based on the acquired position information, a preceding contact operation and a succeeding contact operation performed before and after a non-contact period with respect to the touch panel; and
determining that the preceding contact operation and the succeeding contact operation are one continuous operation when an elapsed time and a positional interval satisfy a given condition, the elapsed time being from finish of the preceding contact operation being detected until start of the succeeding contact operation being detected, and the positional interval being between a finish position at which the finish of the preceding contact operation has been detected and a start position at which the start of the succeeding contact operation has been detected.

8. An operation detection method comprising:
acquiring position information indicating a contact position of an indicator with respect to a touch panel;
detecting, based on the acquired position information, a preceding contact operation and a succeeding contact operation performed before and after a non-contact period with respect to the touch panel; and
determining, by a processor, that the preceding contact operation and the succeeding contact operation are one continuous operation when an elapsed time and a positional interval satisfy a given condition, the elapsed time being from finish of the preceding contact operation being detected until start of the succeeding contact operation being detected, and the positional interval being between a finish position at which the finish of the preceding contact operation has been detected and a start position at which the start of the succeeding contact operation has been detected.
